(19) United States
(12) Patent Application Publication
(10) Pub. No.: US 2025/0253912 A1
(43) Pub. Date: Aug. 7, 2025

(54) SYSTEMS AND METHODS FOR BASIS-BASED COMPRESSION OF DOPPLER COEFFICIENTS FOR CSI FEEDBACK

(71) Applicant: Samsung Electronics Co., Ltd., Suwon-si, Gyeonggi-do (KR)

(72) Inventors: Karthik MURALIDHAR, Bangalore (IN); Dattaraj Dileep Raut MULGAONKAR, Bangalore (IN); Diwakar SHARMA, Bangalore (IN); Eko Nugroho ONGGOSANUSI, Bangalore (IN); Md Saifur RAHMAN, Bangalore (IN); Santanu MONDAL, Bangalore (IN); Youngrok JANG, Suwon-si (KR); Ameha Tsegaye ABEBE, Suwon-si (KR); Naveed ANJUM, Bangalore (IN)

(21) Appl. No.: 18/855,217

(22) PCT Filed: Apr. 10, 2023
(86) PCT No.: PCT/KR2023/004794

§ 371 Date: Oct. 8, 2024

(30) Foreign Application Priority Data
Apr. 8, 2022 (IN) 202241021218
May 30, 2022 (IN) 202241030917
Mar. 21, 2023 (IN) 202341018975
Mar. 31, 2023 (IN) 2022 41021218

(51) Int. Cl. H04B 7/06; H04B 17/373; H04L 25/02

(52) U.S. Cl. CPC H04B 7/0658; H04B 17/373; H04L 25/0204

(57) ABSTRACT

The disclosure relates to a 5G or 6G communication system for supporting a higher data transmission rate. Embodiments disclosed herein relate to systems (100) and methods (400, 800) for performing a basis-based compression of Doppler coefficients for Channel State Information (CSI) feedback in wireless communication networks. The systems (100) and methods (400, 800) implement the CSI feedback for a User Equipment (UE) (102) with less number of basis coefficients and with reduced feedback in reporting the basis coefficients. The systems (100) and methods (400, 800) facilitate differential reporting of Doppler frequency components across beams and sub-bands/delays for the CSI feedback. The systems (100) and methods (400, 800) enable a base station (104) to determine the length of an Observation Window (OW) and Prediction Window (PW) for triggering the OW and PW for reporting feedback. The systems (100) and methods (400, 800) use Slepian sequences for spatial domain basis for codebook based enhancements at a base station transmitter.

### TECHNICAL FIELD

The disclosure relates generally to wireless communication networks, and more specifically, the disclosure relates to performing a basis-based compression of Doppler coefficients for Channel State Information (CSI) feedback in the wireless communication networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The disclosure may disclose systems and methods for basis-based compression of Doppler coefficients for Channel State Information (CSI) feedback in wireless communication networks.

The disclosure may disclose systems and methods for implementing the CSI feedback for a User Equipment (UE) with less number of basis coefficients.

The disclosure may disclose systems and methods for implementing the CSI feedback for the UE with reduced feedback in reporting the basis coefficients.

The disclosure may disclose systems and methods for facilitating differential reporting of Doppler frequency components across beams and sub-bands/delays for the CSI feedback.

The disclosure may disclose systems and methods for enabling a base station to determine the length of an Observation Window (OW) and Prediction Window (PW) for triggering the OW and PW for reporting feedback.

The disclosure may disclose systems and methods for reducing the CSI feedback rate and avoiding the feedback overhead which enhances the efficiency of the communication system.

The disclosure may disclose systems and methods for using Slepian sequences or other basis for spatial domain basis for codebook based enhancements at a base station transmitter in the wireless communication networks.

### Solution to Problem

Accordingly, the embodiments herein provide a method for a Channel State Information (CSI) feedback in a wireless communication system. The method includes receiving, by a User Equipment (UE), a plurality of Channel State Information Reference Signals (CSI-RS) from a base station in an Observation Window (OW) over a plurality of time instants and a plurality of sub-bands or sub-carriers. The method includes predicting, by the UE, at least one channel for each sub-band in selected time instants in a Prediction Window (PW). The method includes estimating, by the UE, at least one basis and at least one relevant basis coefficient of the predicted channel in the PW. The method includes projecting, by the UE, the predicted channel on to the estimated basis. The method includes reporting, by the UE, the relevant basis coefficient of the predicted channel projected over basis to the base station. The method includes reconstructing, by the base station, the channel in the PW using the received basis coefficients over the sub-bands or sub-carriers. The method includes receiving, by the UE, a downlink in the PW which used at least one pre-coder based on the reconstructed channel from the base station.

Accordingly, the embodiments herein provide a UE which comprises a processor. The processor is configured to receive a plurality of CSI-RS from a base station over a plurality of time instants in the OW across sub-bands or sub-carriers. The processor is configured to predict at least one channel for each sub-band in selected time instants in the PW. The processor is configured to estimate at least one basis and at least one relevant basis coefficient of the predicted channel in the PW. The processor is configured to project the predicted channel on to the estimated basis. The processor is configured to report the relevant basis coefficient of the predicted channel projected over basis to the base station. The base station is configured to reconstruct the channel in the PW using the received basis coefficients over the sub-bands or sub-carriers. The processor is configured to receive a downlink in the PW which used at least one pre-coder based on the reconstructed channel from the base station.

Accordingly, the embodiments herein provide a base station which comprises a processor. The processor is configured to transmit a plurality of CSI-RS to the UE over a plurality of time instants in the OW across a plurality of sub-bands or sub-carriers. The processor is configured to receive at least one basis coefficient of a channel projected over basis. The channel predicted by the UE is projected on to the basis. The processor is configured to predict at least one pre-coder for a downlink in the PW for the UE using the received basis coefficients for reconstructing the channel. The processor is configured to transmit the downlink in the PW using the predicted pre-coder to the UE for at least one time instant.

Accordingly, the embodiments herein provide a method for using Slepian sequences or other basis based sequences for spatial domain basis for codebook based enhancements. The method includes receiving, by the UE, a plurality of CSI-RS from the base station across a plurality of sub-bands or sub-carriers. The method includes estimating, by the UE, a two-dimensional (2D) channel matrix for each receiver and each sub-band in the UE and all transmit antennas in the base station that has a 2D layout. The method includes reporting, by the UE, the estimated 2D channel matrix to the base station for each receiver and each sub-band in the UE. The method includes reconstructing, by the base station, at least one channel for the reported 2D channel matrix and calculating at least one precoder based on the reconstructed channel for a downlink transmission. The method includes receiving, by the UE, the downlink which used the pre-coder based on the reconstructed channel from the base station.

Accordingly, the embodiments herein provide a UE which comprises a processor. The processor is configured to receive a plurality of CSI-RS from the base station across a plurality of sub-bands. The processor is configured to estimate a 2D channel matrix for each receiver and each sub-band in the UE and all transmit antennas in the base station that has a 2D layout. The processor is configured to report the estimated 2D channel matrix to the base station for each receiver and each sub-band in the UE. The base station is configured to reconstruct channel for the reported 2D channel matrix and calculate at least one precoder based on the reconstructed channel for a downlink transmission. The processor is configured to receive the downlink which used the pre-coder based on the reconstructed channel from the base station.

Accordingly, the embodiments herein provide a base station which comprises a processor. The processor is configured to transmit a plurality of CSI-RS to the UE across a plurality of sub-bands. The processor is configured to receive an estimated 2D channel matrix from the UE for each receiver and each sub-band in the UE. The UE estimates the 2D channel matrix for each receiver and each sub-band in the UE and all transmit antennas in the base station that has a 2D layout. The processor is configured to reconstruct at least one channel for the received 2D channel matrix and calculate at least one precoder based on the reconstructed channel for a downlink transmission. The processor is configured to transmit the downlink using the predicted pre-coder to the UE based on the reconstructed channel.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

The disclosure may disclose systems and methods for basis-based compression of Doppler coefficients for Channel State Information (CSI) feedback in wireless communication networks.

The disclosure may disclose systems and methods for implementing the CSI feedback for a User Equipment (UE) with less number of basis coefficients.

The disclosure may disclose systems and methods for implementing the CSI feedback for the UE with reduced feedback in reporting the basis coefficients.

The disclosure may disclose systems and methods for facilitating differential reporting of Doppler frequency components across beams and sub-bands/delays for the CSI feedback.

The disclosure may disclose systems and methods for enabling a base station to determine the length of an Observation Window (OW) and Prediction Window (PW) for triggering the OW and PW for reporting feedback.

The disclosure may disclose systems and methods for reducing the CSI feedback rate and avoiding the feedback overhead which enhances the efficiency of the communication system.

The disclosure may disclose systems and methods for using Slepian sequences or other basis for spatial domain basis for codebook based enhancements at a base station transmitter in the wireless communication networks.

### BRIEF DESCRIPTION OF DRAWINGS

Embodiments herein are illustrated in the accompanying drawings, through out which like reference letters indicate corresponding parts in the various figures. The embodiments herein will be better understood from the following description with reference to the drawings, in which:

FIG. 1 depicts a system for providing a Channel State Information (CSI) feedback in a wireless communication system, according to embodiments as disclosed herein;

FIG. 2 depicts a plurality of modules of a processor of a User Equipment (UE), according to embodiments as disclosed herein;

FIG. 3 depicts a plurality of modules of a processor of a base station, according to embodiments as disclosed herein;

FIG. 4 depicts a method for providing the CSI feedback in a wireless communication system, according to embodiments as disclosed herein;

FIG. 5 depicts an overview of a basis-based compression of Doppler coefficients for the CSI feedback in the wireless communication network, according to embodiments as disclosed herein;

FIG. 6A depicts simulation results, according to embodiments as disclosed herein;

FIG. 6B depicts simulation results, according to embodiments as disclosed herein;

FIG. 6C depicts simulation results, according to embodiments as disclosed herein;

FIG. 6D depicts simulation results, according to embodiments as disclosed herein;

FIG. 6E depicts simulation results, according to embodiments as disclosed herein;

FIG. 6F depicts simulation results, according to embodiments as disclosed herein;

FIG. 6G depicts simulation results, according to embodiments as disclosed herein;

FIG. 6H depicts simulation results, according to embodiments as disclosed herein;

FIG. 6I depicts simulation results, according to embodiments as disclosed herein;

FIG. 7 depicts variation in x-axis with quantization for feedback of Doppler coefficients, according to embodiments as disclosed herein;

FIG. 8 depicts a method for using Slepian sequences or other basis for a spatial domain (SD) basis for codebook based enhancements at the base station transmitter, according to embodiments as disclosed herein;

FIG. 9 depicts a desired beamforming array response of a uniform linear array, according to embodiments as disclosed herein;

FIG. 10 depicts low pass time domain signals, according to embodiments as disclosed herein;

FIG. 11A depicts an example of low pass/band pass time domain signals, according to embodiments as disclosed herein;

FIG. 11B depicts an example of low pass/band pass time domain signals, according to embodiments as disclosed herein;

FIG. 12A depicts an example of basis coefficients of the low pass signal, according to embodiments as disclosed herein;

FIG. 12B depicts an example of basis coefficients of the low pass signal, according to embodiments as disclosed herein;

FIG. 13A depicts the 2D FFT for the CDL channel that has only one cluster and it's down converted version, according to embodiments as disclosed herein;

FIG. 13B depicts the 2D FFT for the CDL channel that has only one cluster and it's down converted version, according to embodiments as disclosed herein;

FIG. 14A depicts an example radiation pattern of DFT and Slepian beams for various half widths, according to embodiments as disclosed herein;

FIG. 14B depicts an example radiation pattern of DFT and Slepian beams for various half widths, according to embodiments as disclosed herein;

FIG. 14C depicts an example radiation pattern of DFT and Slepian beams for various half widths, according to embodiments as disclosed herein;

FIG. 14D depicts an example radiation pattern of DFT and Slepian beams for various half widths, according to embodiments as disclosed herein;

FIG. 14E depicts an example radiation pattern of DFT and Slepian beams for various half widths, according to embodiments as disclosed herein;

FIG. 15 depicts an example plot of the percentage of power in the desired region, according to embodiments as disclosed herein;

FIG. 16A depicts 2D FFTs of a single cluster CDL channel and two cluster CDL channel respectively, according to embodiments as disclosed herein;

FIG. 16B depicts 2D FFTs of a single cluster CDL channel and two cluster CDL channel respectively, according to embodiments as disclosed herein;

FIG. 17A depicts an example of leakages of down converted low pass 2D FFT signal of a CDL channel, according to embodiments as disclosed herein;

FIG. 17B depicts an example of leakages of down converted low pass 2D FFT signal of a CDL channel, according to embodiments as disclosed herein;

FIG. 18A depicts example reconstruction errors for the Slepian basis and the DFT basis, according to embodiments as disclosed herein; and

FIG. 18B depicts example reconstruction errors for the Slepian basis and the DFT basis, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

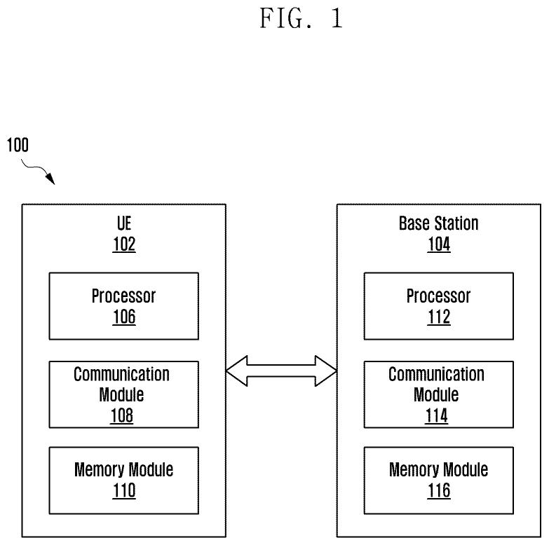

The embodiments herein provide systems and methods for performing basis-based compression of a channel or Doppler coefficients of a channel for Channel State Information (CSI) feedback in wireless communication networks, which results in lesser feedback (as compared to existing methods). Referring now to the drawings, and more particularly to FIGS. 1 through 18, where similar reference characters denote corresponding features consistently throughout the figures, there are shown embodiments.

Matlab notation followed to access matrices/perform operations is as follows:
A matrix is represented by BOLD UPPERCASE vectors by bold lowercase and scalars by normal font.
A.*B is a matrix with same dimensions as A, B obtained by element-wise multi-plication of A and B.
N×N FFT matrix is F_{N} defined as

$$F ( i , j ) = {e}^{\frac{j 2 π ij}{N}} , 0 \leq i , j \leq N - 1.$$

The ath column of F_{N} is denoted by f_{a,N}. The cyclically shifted version of f_{a,N} (upward) by b positions is denoted by f_{a,N}^{(b)}.
The cyclically shifted version of a column vector x(downward) by b positions is denoted by X^{(b)}.
A⊗B defines the Kronecker product of matrices A, B
Estimate of x is denoted as \hat{x}. * denotes conjugate.
A^{T} denotes transpose of A (likewise for vector x). A^{H} denotes transpose conjugate of A (likewise for vector x).

x is a vector then x.\hat{ }a is a vector of same dimensions as x whose pth element is x(p )\hat{ }a where \hat{ } is the exponent operation.

In general, base stations employ adaptive modulation and coding (AMC) techniques which allow adjustment of different modulation and coding schemes (MCS). The MCS adjustment facilitates each user with the highest quality of service, by transmitting data according to the channel state information (CSI) signals fed back from the users. Timely CSI signaling is necessary for allocating wireless resources to the users and for maximizing the overall network capacity.

If a user equipment (UE) does not move or moves slowly, then the channel coherence time is large and the CSI needs to be less frequently updated. However, if the UE moves fast, then the channel coherence time is short and the transmit signals experience severe fading caused by a Doppler-frequency spread. Thus, the CSI needs to be updated frequently which causes a high feedback overhead.

Multiple-Input Multiple-Output (MIMO) evolution for downlink (DL) and uplink (UL) provides a CSI reporting enhancement for high/medium UE velocities by exploiting time-domain correlation/Doppler-domain information to assist DL precoding and targeting FR1 (low frequency bands), as follows:
Relese-16/17 Type-II codebook refinement, without modification to the spatial and frequency domain basis,
UE reporting of time-domain channel properties measured via Channel State Information Reference Signal (CSI-RS) for tracking.”

Assuming a system with N₃ sub-bands and 2L Spatial Domain (SD) beams, the frequency domain correlation inside W₂ can be exploited by applying a discrete Fourier transform (DFT) compression on top of W₂ which is of size 2L×N₃. In a frequency compression matrix of size N₃×M, W_{f} is selected from the columns of an oversampled DFT codebook, where W_{f} forms an orthogonal subset of a basis set found in the DFT codebook. M<N₃ is the number of Frequency Domain (FD) basis vectors that are selected after compression. FD compression is applied to each layer 1 to obtain a matrix of linear combination coefficients: W₂

$${\tilde{W}}_{2} = {W}_{2} {W}_{f} \qquad ( 1 )$$

W_{f} can be regarded as the equivalent of the 2N₁N₂×2L matrix W₁ for frequency compression. The final precoder format can be written as:

$$W = {W}_{1} {\tilde{W}}_{2} {W}_{f}^{H} \qquad ( 2 )$$

The elements inside \tilde{W}₂ shall be referred to as FD coefficients.

N_{T}=N₁×N₂, antennas in a panel and two polarizations. Here, W is the concatenation of precoder matrix for N₃ sub-bands. W₁, W₂, \tilde{W}₂, W_{f} for a particular sub-band be extended across multiple time instants (third dimension) in presence of Doppler as follows:
W₁ be 2N_{T}×2L (2 no. of Tx antennas per pol. x 2 no. of beams).
W₂ be 2L×N₃×N (2 no. of beams x no. of sub-bands x no. of time instants).
\tilde{W}₂ be 2L×M×n (2 no. of beams x no. of FD compressed elements x no. of time instants).
W_{f} is N₃×M matrix.

The Doppler-space domain precoder for the l-th transmission layer, the s-th sub-band, the two polarizations for T occasions of CST-RS is given by:

$${P}^{( l )} ( s ) = {P}^{( l )} = [ \begin{matrix}{\sum }_{u = 0}^{{U}^{( l )} - 1} {\sum }_{v = 0}^{{F}_{u}^{( l )} - 1} {γ}_{1 , s , u , v}^{( l )} {f}_{1 , u , v}^{( l )} ⊗ {b}_{u}^{( l )} \\ {\sum }_{u = 0}^{{U}^{( l )} - 1} {\sum }_{v = 0}^{{F}_{u}^{( l )} - 1} {γ}_{2 , s , u , v}^{( l )} {f}_{2 , u , v}^{( l )} ⊗ {b}_{u}^{( l )}\end{matrix} ]$$

which is W₁W₂(:, s, 1: T) after dropping the second dimension (similar to matlab squeeze function) in W₂ where,

U^{(l)} is the number of beams per polarization for the l-th layer,

Fᵤ(l) is the number of Doppler-frequency components for the l-th layer and u-th beam,

bᵤ^{(l)} is the u-th spatial beam associated with the l-th layer;

f_{p,u,v}^{(l)} is the v-th Doppler-frequency vector (DFT based) of size 1×T associated with the l-th layer, u-th spatial beam, and the p-th (p=1,2)polarization of the precoder,

γ_{p,s,u,b}^{(l)} is the complex combination coefficient associated with the l-th layer, uth spatial beam, v-th Doppler-frequency, s-th sub-band, and the p-th polarization of the precoder, and

P^{(l)} is a scalar normalisation factor to ensure a certain total transmission power.

The total feedback is the sum of Doppler frequency locations and Doppler frequency coefficients across beams and layers. The former is given by 2Σ_{u,l}Fᵤ^{(l)} and the latter is given by γ_{p,s,u,v}^{(l)} for all p,u,v,l.

The Precoding Matrix Index (PMT) report containing the Doppler-frequency components can be used at a base station gNB within the stationarity time of the channel to facilitate predictive multi-user scheduling and/or multi-user precoder matrix prediction. For example, for the precoder matrix prediction, the length-T Doppler-frequency DFT-vectors f_{p,u,v}^{(l)} reconstructed at the gNB based on the PMI report and extended to length-QT vectors t_{p,u,v}^{(l)}, the extension defined by

$${t}_{p , u , v}^{( l )} = [ 1 , … , {e}^{j 2 π k q} , … , {e}^{j 2 π k ( Q - 1 )} ] ⊗ {f}_{p , u , v}^{( l )} ,$$

is the selected DFT vector from the

$${f}_{p , u , v}^{( l )} = [ 1 , {e}^{j \frac{2 π k}{T}} , … , {e}^{j \frac{2 π k ( T - 1 )}{T}} ]$$

DFT Doppler codebook, where k is a multiple of 1/0 with 0 being oversampling factor. The predicted Doppler-space precoder matrix for the l-th layer, s-th sub-band, and q-th (q=1, . . . , QT) future time instant is then given by,

$${P}^{( l )} ( s , q ) = {P}^{( l )} = [ \begin{matrix}{\sum }_{u = 0}^{{U}^{( l )} - 1} {\sum }_{v = 0}^{{F}_{u}^{( l )} - 1} {γ}_{1 , s , u , v}^{( l )} {t}_{1 , u , v}^{( l )} ( q ) ⊗ {b}_{u}^{( l )} \\ {\sum }_{u = 0}^{{U}^{( l )} - 1} {\sum }_{v = 0}^{{F}_{u}^{( l )} - 1} {γ}_{2 , s , u , v}^{( l )} {t}_{2 , u , v}^{( l )} ( q ) ⊗ {b}_{u}^{( l )}\end{matrix} ] ,$$

where t_{p,u,v}^{(l)}(q) is the q-th entry of vector t_{p,u,v}^{(l)}

The Delay-Doppler-space domain precoder for the l-th transmission layer, the two polarizations for T occasions of the CST-RS and all sub-bands is given by

$${P}^{( l )} = {P}^{( l )} = [ \begin{matrix}{\sum }_{u = 0}^{{U}^{( l )} - 1} {\sum }_{d = 0}^{{D}_{u}^{( l )} - 1} {\sum }_{v = 0}^{{F}_{d , u}^{( l )} - 1} {γ}_{1 , s , u , v}^{( l )} {d}_{1 , u , d}^{( l )} ⊗ {f}_{1 , u , v}^{( l )} ⊗ {b}_{u}^{( l )} \\ {\sum }_{u = 0}^{{U}^{( l )} - 1} {\sum }_{d = 0}^{{D}_{u}^{( l )} - 1} {\sum }_{v = 0}^{{F}_{d , u}^{( l )} - 1} {γ}_{2 , s , u , v}^{( l )} {d}_{2 , u , d}^{( l )} ⊗ {f}_{2 , u , v}^{( l )} ⊗ {b}_{u}^{( l )}\end{matrix} ]$$

which is (I_{S}⊗W₁)W₂ where I_{S} is S×S identity matrix, S is number of sub-bands.
U^{(l)} is the number of beams per polarization for the l-th layer,
Fᵤ^{(l)} is the number of Doppler-frequency components for the l-th layer and u-th beam,
bᵤ^{(l)} is the u-th spatial beam associated with the l-th layer;
f_{p,u,d,v}^{(l)} is the v-th Doppler-frequency vector (DFT based) of size associated with the l-th layer, u-th spatial beam, dth delay, and the p-th (p=1,2) polarization of the precoder,
d_{p,u,d}^{(l)} is S×1 d-th delay vector (DFT based) associated with p-th polarization and u-th beam.
γ_{p,d,u,v}^{(l)} is the Doppler frequency coefficient associated with the l-th layer, u-th spatial beam, v-th Doppler-frequency, d-th delay and the p-th polarization of the precoder, and
P^{(l)} is a scalar normalisation factor to ensure a certain total transmission power.

The total feedback is the sum of Doppler frequency locations across all delays and 2(Σ_{u,l}Dᵤ^{(l)}+Σ_{u,d,l}F_{d,u}^{(l)}) and the latter is given by γ_{p,d,u,v}^{(l)} for all p,u,d,v.

The PMI report containing the Doppler-frequency components can be used at the gNB within the stationarity time of the channel to facilitate predictive multi-user scheduling and/or multi-user precoder matrix prediction. For example, for the precoder matrix prediction, the length-T Doppler-frequency DFT-vectors f_{p,u,d,v}^{(l)} are reconstructed at the gNB based on the PMI report and extended to length-QT vectors, the extension defined by

$${t}_{p , u , d , v}^{( l )} = [ 1 , … , {e}^{j 2 π k q} , … , {e}^{j 2 π k ( Q - 1 )} ] ⊗ {f}_{p , u , d , v}^{( l )} ,$$

where

$${t}_{p , u , d , v}^{( l )} = [ 1 , {e}^{j \frac{2 π k}{T}} , … , {e}^{j \frac{2 π k ( T - 1 )}{T}} ] ,$$

where k is a multiple of 1/0 with 0 being oversampling factor. The predicted delay-Doppler-space precoder matrix for the l-th layer, s-th sub-band, and q-th (q=1, . . . , QT) future time instant is then given by:

$${P}^{( l )} = {P}^{( l )} = [ \begin{matrix}{\sum }_{u = 0}^{{U}^{( l )} - 1} {\sum }_{d = 0}^{{D}_{u}^{( l )} - 1} {\sum }_{v = 0}^{{F}_{d , u}^{( l )} - 1} {γ}_{1 , s , u , v}^{( l )} {d}_{1 , u , d}^{( l )} ⊗ {t}_{1 , u , v}^{( l )} ( q ) ⊗ {b}_{u}^{( l )} \\ {\sum }_{u = 0}^{{U}^{( l )} - 1} {\sum }_{d = 0}^{{D}_{u}^{( l )} - 1} {\sum }_{v = 0}^{{F}_{d , u}^{( l )} - 1} {γ}_{2 , s , u , v}^{( l )} {d}_{2 , u , d}^{( l )} ⊗ {t}_{2 , u , v}^{( l )} ( q ) ⊗ {b}_{u}^{( l )}\end{matrix} ]$$

where t_{p,u,d,v}^{(l)}(q) is the q-th entry of vector t_{p,u,d,v}^{(l)}

Currently, Type1 and Type-2 codebook in 5G use DFT-based spatial basis matrix (for w1). However, there are certain drawbacks associated with the use of DFT basis at the gNB transmitters.

Therefore, the CSI feedback using the existing Doppler frequency DFT basis method comprises more basis coefficients which may result in more feedback scenarios.

FIG. 1 depicts a system 100 for providing a Channel State Information (CSI) feedback in a wireless communication system. The system 100 comprises a User Equipment (UE) 102, and a base station 104. The UE 102 further comprises a processor 106, a communication module 108, and a memory module 110.

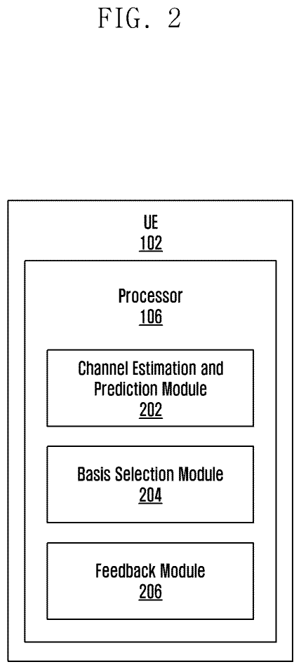

In an embodiment herein, the processor 106 is configured to perform a basis-based compression of a channel or Doppler coefficients of a channel for the reduced CSI feedback. The processor 106 further comprises a channel estimation and prediction module 202, a basis selection module 204, and a feedback module 206 as depicted in FIG. 2.

In an embodiment herein, the channel estimation and prediction module 202 can receive a plurality of Channel State Information Reference Signals (CSI-RS) from a base station 104 in an Observation Window (OW). The channel estimation and prediction module 202 can receive the CSI-RS across a plurality of sub-bands from the base station 104 for various time instants in the OW. A sub-band is a set of sub-carriers. The channel estimation and prediction module 202 can predict at least one channel for each sub-band in selected time instants in a Prediction Window (PW). In an embodiment herein, the channel estimation and prediction module 202 can predict the channel in a delay domain over the PW and report at least one relevant basis coefficient for the channel in the delay domain over the PW. The predicted channel is the channel between the base station 104 and the UE 102 or elements of parts of precoder matrices across time in the PW (the parts of precoder matrices are W₂ or \tilde{W}₂). In an embodiment herein, the channel estimation and prediction module 202 can estimate a two-dimensional (2D) channel matrix for each receiver and each sub-band in the UE 102 and all transmit antennas in the base station 104 that has a 2D layout. Further, 2D Fast Fourier Transform (2D FFT) of the 2D channel matrix is performed. The channel estimation and prediction module 202 can determine a location and number of clusters in the estimated 2D FFT of the 2D channel matrix. The channel estimation and prediction module 202 can down convert each cluster based on a 2D exponential. The channel estimation and prediction module 202 can estimate a one-dimensional (1D) channel matrix if a channel layout of the transmit antennas in the base station 104 is 1D. In an embodiment herein, the channel estimation and prediction module 202 estimates the channel in the OW using CSI-RS and uses these estimates to predict the channel in the PW. Prediction can be based on neural network/deep learning models like Recurrent Neural Network (RNN), Long Short-Term Memory (LSTM) networks, conventional signal processing modules/algorithms like Auto-Regressive model (AR) estimation, Yule-Walker equations, Weiner prediction and so on or it could also be based on estimating the Doppler components of the estimated channel in the OW.

In an embodiment herein, the UE 102 separates each cluster from the estimated channel. To separate a desired cluster from the channel, the 2D FFT of the channel is taken and the 2D FFT bin values corresponding to all clusters other than the desired cluster are equated to zero and in an embodiment herein, a 2D Inverse FFT (IFFT) is used to arrive at the desired cluster.

In an embodiment herein, to separate a desired cluster from the channel, the 2D FFT of the channel is taken and the 2D FFT bin values corresponding to the desired cluster is equated to zero. Later, the 2D IFFT of the remaining 2D signal is taken and subtracted from the 2D channel.

In an embodiment herein, the 2D exponential corresponding to the desired cluster is calculated. The 2D exponential is the approximate location of the desired cluster in the 2D FFT of the channel. The channel is projected onto a subspace that is orthogonal to an up converted 2D signal subspace. The up conversion corresponds to the 2D exponential of the desired cluster. This projection is subtracted from the channel to arrive at the desired cluster.

In an embodiment herein, a subspace is spanned by one or more basis vectors. A low pass signal lies in a signal subspace, and the dimension (no. of basis vectors in the subspace) is dependent on the low pass signal or by design. This low pass signal is said to lie in the signal subspace or signal basis. If all of the basis vectors are in a signal subspace or multiplied by the 2D exponential, then that signal subspace or signal basis is up converted by the 2D exponential. Here, All basis are 2D in nature.

In an embodiment herein, the basis selection module 204 can estimate at least one set of basis and at least one relevant basis coefficient of the predicted channel in the PW. The basis selection module 204 can project the predicted channel for various time instants in the PW on to the basis. Examples of the basis can be, but not limited to a Slepian (discrete prolate spheroidal sequence) basis, a Fast Fourier transform (FFT) basis, a Discrete Cosine Transform (DCT) basis, a Discrete Fourier Transform (DFT) basis, an oversampled DFT basis, a polynomial basis or any other relevant basis. In an embodiment herein, the oversampled DFT basis provides the CSI feedback using a differential reporting of location and values of Doppler frequency components, corresponding to the channel in the sub-band for various time instants in the PW. In an embodiment herein, the oversampled DFT basis provides the CSI feedback using the differential reporting of location and values of Doppler frequency components, corresponding to the channel in the delay domain for various time instants in the PW. The differential reporting is a difference with respect to a reference reported along with the reference. In an embodiment herein, the basis selection module 204 can project the down converted each cluster from the channel estimation and prediction module 202 onto a 2D signal basis or a 2D signal subspace to obtain signal basis coefficients. The 2D signal subspace is composed of basis vectors. Examples of the basis vectors can be, but not limited to, the Slepian (discrete prolate spheroidal sequence) basis, the FFT basis, the DCT basis, the DFT basis, an oversampled DFT basis, and the polynomial basis.

In an embodiment herein, the feedback module 206 can report the relevant basis coefficient of the predicted channel projected at least one basis to the base station 104. The UE 102 can receive a downlink in the PW, from the base station 104, which used at least one pre-coder based on reconstructed channel. In an embodiment herein, the feedback module 206 can report the estimated 2D channel matrix corresponding to all transmit antennas of base station to the base station 104 for each receiver and each sub-band in the UE 102. The UE 102 can receive the downlink, from the base station 104, which used the pre-coder based on the reconstructed channel. In an embodiment herein, the feedback module 206 can report a plurality of relevant signal basis coefficients along with the 2D exponential for each of the clusters (or at least one cluster) of the 2D channel to the base station 104.

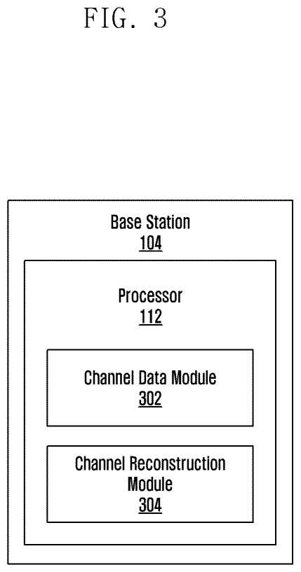

The base station 104 further comprises a processor 112, a communication module 114, and a memory module 116 as depicted in FIG. 3.

In an embodiment herein, the processor 112 is configured to reconstruct the channel in the PW using the received basis coefficients from the processor 106 of the UE 102. The processor 112 further comprises a channel data module 302 and a channel reconstruction module 304.

In an embodiment herein, the channel data module 302 can transmit a plurality of CSI-RS to the UE 102 for various time instants in the OW. The channel data module 302 can transmit the CSI-RS across a plurality of sub-bands.

In an embodiment herein, the channel reconstruction module 304 can receive at least one basis coefficient of a channel projected at least one basis from the feedback module 206 of the UE 102. The channel predicted by the UE 102 is projected on to the basis. The channel reconstruction module 304 can predict at least one pre-coder for a downlink in the PW for the UE 102, using the received basis coefficients. The channel reconstruction module 304 can transmit the downlink in the PW using the predicted pre-coder to the UE 102 for at least one time instant based on the reconstructed channel. In an embodiment herein, the channel reconstruction module 304 can reconstruct the estimated 2D channel matrix from feedback received from the UE 102 for each receiver and each sub-band in the UE 102. The UE 102 estimates the 2D channel matrix for each receiver and each sub-band in the UE 102 and all transmit antennas in the base station 104 that has a 2D layout. The channel reconstruction module 304 can reconstruct at least one channel for the received 2D channel matrix and calculate at least one precoder based on the reconstructed at least one channel for a later downlink transmission to the UE 102 in the PW. The channel reconstruction module 304 can reconstruct the channel and calculate the precoder from the reported exponential and basis coefficients of the clusters of the 2D channel seen by the UE 102. The channel reconstruction module 304 can transmit the downlink in the PW using the predicted pre-coder to the UE 102 based on the reconstructed channel.

In an embodiment herein, the processor 106 and the processor 112 can process and execute data of a plurality of modules of the UE 102 and base station 104. The processor 106 and the processor 112 can be configured to execute instructions stored in the memory module 110 and the memory module 116. The processor 106 and the processor 112 may comprise one or more of microprocessors, circuits, and other hardware configured for processing. The processor 106 and the processor 112 can be at least one of a single processer, a plurality of processors, multiple homogeneous or heterogeneous cores, multiple Central Processing Units (CPUs) of different kinds, micro-controllers, special media, and other accelerators. The processor 106 and the processor 112 may be an application processor (AP), a graphics-only processing unit such as a graphics processing unit (GPU), a visual processing unit (VPU), and/or an Artificial Intelligence (AI)—dedicated processor such as a neural processing unit (NPU).

In an embodiment herein, the plurality of modules of the processor 106 of the UE 102 can communicate with the base station 104 via the communication module 108. The plurality of modules of the processor 112 of base station 104 can communicate with the UE 102 via the communication module 114. The communication modules 108 and 114 may be in the form of either a wired network or a wireless communication network. The wireless communication network may comprise, but not limited to, GPS, GSM, Wi-Fi, Bluetooth low energy, NFC, and so on. The wireless communication may further comprise one or more of Bluetooth, ZigBee, a short-range wireless communication such as UWB, and a medium-range wireless communication such as Wi-Fi or a long-range wireless communication such as 3G/4G/5G/6G and non-3GPP technologies or WiMAX, according to the usage environment.

In an embodiment herein, the memory modules 110 and 116 may comprise one or more volatile and non-volatile memory components which are capable of storing data and instructions of the modules of the UE 102 and the base station 104 to be executed. Examples of the memory modules 110 and 116 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory modules 110 and 116 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory modules 110 and 116 may, in some examples, be considered a non-transitory storage medium. The term “non-transitory” may indicate that the storage medium is not embodied in a carrier wave or a propagated signal. However, the term “non-transitory” should not be interpreted to mean that the memory modules 110 and 116 are non-movable. In certain examples, a non-transitory storage medium may store data that can, over time, change (e.g., in Random Access Memory (RAM) or cache).

FIGS. 1 to 3 show example modules of the UE 102 and the base station 104, but it is to be understood that other embodiments are not limited thereon. In other embodiments, the UE 102 and the base station 104 may include less or more number of modules. Further, the labels or names of the modules are used only for illustrative purpose and does not limit the scope of the invention. One or more modules can be combined together to perform same or substantially similar function in the UE 102 and the base station 104.

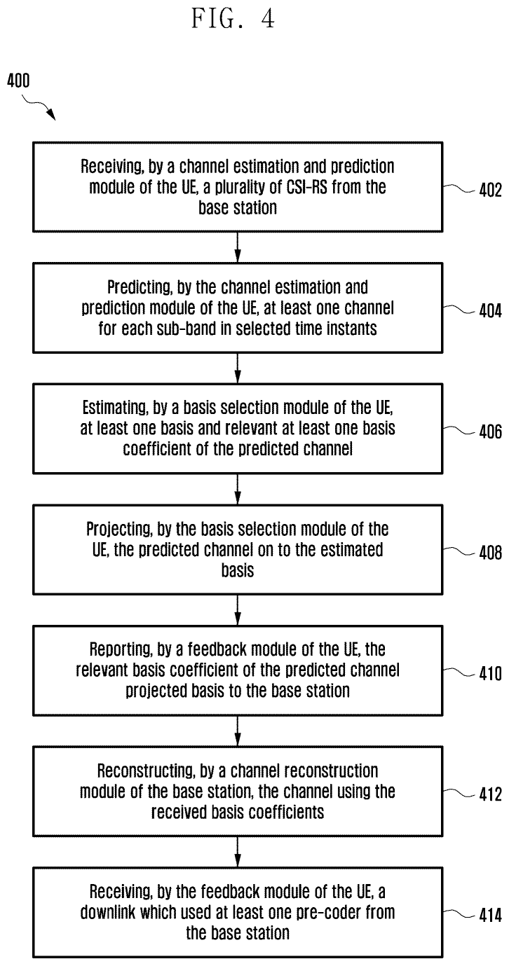

FIG. 4 depicts a method 400 for providing the CSI feedback in a wireless communication system. The method 400 includes receiving, by the channel estimation and prediction module 202 of the UE 102, a plurality of CSI-RS from the base station 104 in the OW, as depicted in step 402. The method 400 includes predicting, by the channel estimation and prediction module 202 of the UE 102, at least one channel for each sub-band in selected time instants in the PW, as depicted in step 404. Thereafter, the method 400 includes estimating, by the basis selection module 204 of the UE 102, at least one basis and at least one relevant basis coefficient of the predicted channel in the PW, as depicted in step 406.

Subsequently, the method 400 includes projecting, by the basis selection module 204 of the UE 102, the predicted channel on to the estimated basis, as depicted in step 408. The method 400 includes reporting, by the feedback module 206 of the UE 102, the relevant basis coefficient of the predicted channel projected over basis to the base station 104, as depicted in step 410. The method 400 includes reconstructing, by the channel reconstruction module 304 of the base station 104, the channel in the PW using the received basis coefficients, as depicted in step 412. Later, the method 400 includes receiving, by the feedback module 206 of the UE 102, a downlink in the PW which used at least one pre-coder based on the reconstructed channel from the base station 104, as depicted in step 414.

The various actions in method 400 may be performed in the order presented, in a different order or simultaneously. Further, in some embodiments, some actions listed in FIG. 4 may be omitted.

For example, in Slepian methods, the Slepian sequences have the least amount of x ∈ [symbol] ₂ ( [symbol] ) and its discrete time Fourier transform (DTFT)

$$\tilde{x} ∈ {L}_{2} ( [ - \frac{1}{2} , \frac{1}{2} ] )$$

is given by

$$\begin{matrix}\tilde{x} ( f ) = {\sum }_{n = - ∞}^{∞} x [ n ] {e}^{- j 2 π fn} , \\ x [ n ] = {\int }_{- 1 / 2}^{1 / 2} \tilde{x} ( f ) {e}^{j 2 π fn} df .\end{matrix}$$

For a given positive integer N and band limit 0<W<1/2, the only signal which is both bandlimited to f ∈[−W,W] and time limited to n ∈{0,1, . . . , N−1} is the zero signal. Time limited signals, whose energy is maximally concentrated in the frequency interval [−W, W], have to be determined.

For any length N signal, x ∈ [symbol] ^{N}

$$\frac{{\int }_{- W}^{W} {\vert \tilde{x} ( f ) \vert}^{2} df}{{\int }_{- 1 / 2}^{1 / 2} {\vert \tilde{x} ( f ) \vert}^{2} df} = \frac{{x}^{*} {B}_{N , W} x}{{x}^{*} x} ,$$

Where B_{N,W} is an N×N matrix with entries.

$${B}_{N , W} [ m , n ] = \{ \begin{matrix}\frac{sin ( 2 π W ( m - n ) )}{π ( m - n )} & if m \neq n \\ 2 W & if m = n\end{matrix}$$

The Slepian basis vectors s_{N,W}⁽⁰⁾,s_{N,W}⁽¹⁾, . . . , s_{N,W}^{(N-1)} are defined as the eigenvectors of B_{N,W}, where the respective eigenvalues λ_{N,W}⁽⁰⁾,λ_{N,W}⁽¹⁾, . . . , λ_{N,W}^{(N-1)} are sorted in decreasing order.

In the Slepian (DPSS) Basis, φ is N×N matrix (N orthogonal columns), that can be generated by matlab dpss (N, thbw, N) function, which generates N (third parameter) sequences of length N (first parameter). thbw called as time_halfbandwidth.

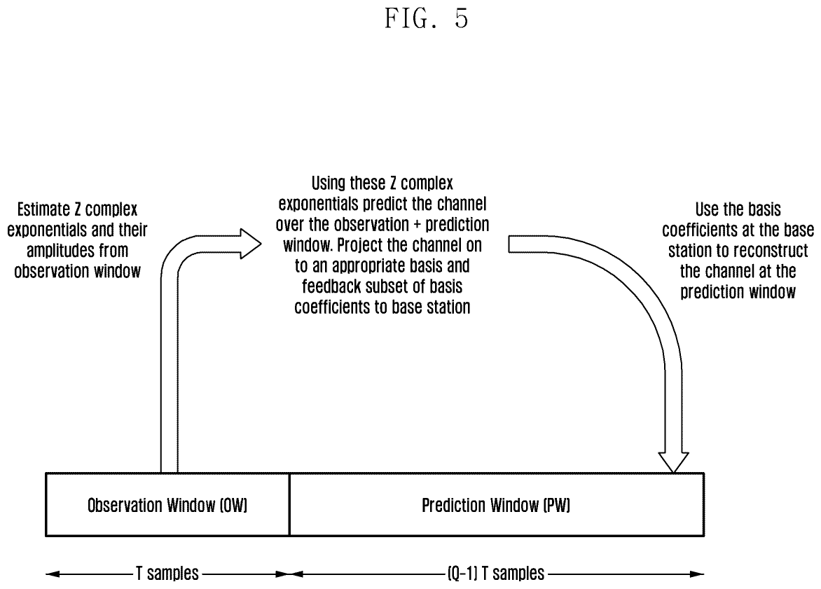

FIG. 5 depicts an overview of a basis-based compression of Doppler coefficients for CSI feedback in the wireless communication network. An Observation Window (OW) of T samples (CSI-RS) with T′ seconds apart is shown, and (Q−1)T time instants in a Prediction Window (PW) is shown where the channel value is to be predicted.

For example, for a channel, elements of W₂ or \tilde{W}₂ across time may be, W₂(b,s,:)W₂(b,s,:) or \tilde{W}₂(b,s,:). Let the channel be approximated by,

$$c ( n ) = {\sum }_{z = 1}^{Z} {a}_{z} {e}^{j 2 π {f}_{z} n} , n = 0 , … QT - 1$$

Here f_{z} is normalized by T′. This means the channel in the OW and the PW is completely determined by Z amplitude values and az frequency locations. Reconstructing c(n) accurately in the base station 104 requires precise values of fz which may consume larger bits.

The method allows the UE 102 to project a vector composed of c(n) for time instants T, . . . . . . , QT−1, on an appropriate basis such as the Slepian basis, the DCT basis, the DFT basis, the polynomial basis, and so on. The method allows the UE 102 to send only the appropriate and relevant basis coefficients.

Based on the selected basis, QT×QT matrix is selected, where φ is the basis matrix. The channel vector c=[c(0) . . . c(QT−1)]^{T} is given as c=φxₐₗₗ, where xₐₗₗ is a vector of basis coefficients. An estimate of the channel vector c=[c(0) . . . c(QT−1)]^{T} is given as ĉ=φ(:,sel)x, where sel is a column vector indicating the columns to be selected in φ, that as an example could correspond to maximum energy of elements in Xₐₗₗ·Xₐₗₗ(Sel)=x, which is a quantized version of x is sent to the base station 104 and is denoted by x^{(Q)}. Here X is a N_{c}×1 basis coefficient vector and is sent as feedback to the base station 104. The base station 104 can reconstruct ĉ and predict channel in the prediction window. The N_{c}×1 basis column selection vector sel is also sent as feedback to the base station 104. This method has no frequency locations to be feedback and hence expected to have low feedback. The base station 104 reconstructs the channel as ĉ=φ(:,sel)x^{(Q)}.

The basis can be the Slepian (discrete prolate spheroidal sequence) basis, the FFT basis, the polynomial basis, the DCT basis and so on.

### Slepian Basis (Discrete Prolate Spheroidal Sequences):

In the QT×QT Slepian matrix, φ is characterized by two parameters, the Normalized Doppler spread f_{D}T′ and length of the sequence QT. All columns of φ are Slepian sequences. The parameter thbw=f_{D}T′ It can also be characterized by thbw and length of the sequence QT. Alternatively, sel can be the first N_{c} columns of φ. The base station 104 and the UE 102 can implement the same and this can be fixed or selected by signalling.

### FFT Basis

In the FFT matrix, φ=F_{QT} can act as FTT basis. Alternatively, sel can be the first

$$\frac{{N}_{c} - 1}{2} + 1$$

columns and last

$$\frac{{N}_{c} - 1}{2}$$

columns of

### Polynomial Basis:

The predicted channel in the PW is a set of piecewise polynomials. For each piecewise polynomial, the basis is constructed. For example, it is depicted how the entire channel in observation+prediction window is fit with a polynomial basis of order P. Let b=[b₀ . . . b_{QT-1}] be the time instants (generally can be [1, . . . , QT] where corresponding to data c is observed. Embodiments herein adopt the centring and scaling method for polynomial basis and compute b̅=(b−μ_{b})σ_{b} where μb is a mean of b and σ_{b} is standard deviation of b. the QT×P polynomial basis matrix is φ=[b̅.\hat{ }0 . . . b̅.\hat{ }(P−1)]. In c=φxₐₗₗ, xₐₗₗ is vector of polynomial coefficients. This method of polynomial fitting is called centring and scaling which improves the numerical properties of the fit. Alternatively, sel can be all columns of φ. In Matlab, the call [xₐₗₗ,˜,mu]=polyfit (b,c,P). where mu=[μ_{b}σ_{b}]. The base station 104 reconstructed channel is ĉ=polyval (xₐₗₗ^{(Q)}, b, [ ], mu).

### Method 1:

The Doppler frequency approximation of elements of W₂ across time (T samples) that are basically complex exponentials are replaced by columns of an appropriate basis matrix. The Doppler-space domain precoder for the l-th transmission layer, the s-th sub-band, the two polarizations for T occasions of CSI-RS is given by,

$${P}^{( l )} ( s ) = {P}^{( l )} [ \begin{matrix}{\sum }_{u = 0}^{{U}^{( l )} - 1} {\sum }_{v = 1}^{{N}_{C}^{( u , s , l , p )}} {x}_{1 , u , s}^{( l )} ( v ) {φ}_{1 , u , s}^{( l ) T} ( 1 : T , sel ( v ) ) ⊗ {b}_{u}^{( l )} \\ {\sum }_{u = 0}^{{U}^{( l )} - 1} {\sum }_{v = 1}^{{N}_{C}^{( u , s , l , p )}} {x}_{2 , u , s}^{( l )} ( v ) {φ}_{2 , u , s}^{( l ) T} ( 1 : T , sel ( v ) ) ⊗ {b}_{u}^{( l )}\end{matrix} ]$$

which is W₁W₂(:,s,1:T) after dropping the second dimension (similar to matlab squeeze function) in W₂, where
U^{(l)} is the number of beams per polarization for the l-th layer,
N_{C}^{(u,s,l,p)} is the number of basis coefficients/vectors corresponding to the u-th beam, s-th sub-band l-th layer and p-th polarization. This can vary for some parameters of (u,s,l,p) and be constant for the remaining parameters of (u,s,l,p).
φ_{p,u,s}^{(l)T}(1:T,sel(v)) is the transpose of the first T values in the sel(v))th column of the basis matrix corresponding to u-th beam, s-th sub-band l-th layer and p-th polarization. This can vary for some parameters of (u,s,l,p) and be constant for the remaining parameters of (u,s,l,p). Likewise tbhw can vary for some parameters of (u,s,l,p) and be constant for the remaining parameters of (u,s,l,p) if the basis is Slepian.
x_{p,u,s}^{(l)}(v) is the v-th element of the basis coefficient vector corresponding to u-th beam, s-th sub-band, l-th layer and p-th polarization.
bᵤ^{(l)} is the u-th spatial beam associated with the l-th layer; P(I) is a scalar normalisation factor to ensure a certain total transmission power.

The total feedback is the number of basis coefficients across beams, layers, sub-bands and polarizations N_{C}^{(u,s,l,p)} for all u,s,l,p. The Precoding Matrix Index (PMI) report containing the basis coefficients can be used at the base station 104 within the stationarity time of the channel to facilitate predictive multi-user scheduling and/or multi-user precoder matrix prediction. For example, for the precoder matrix prediction, the predicted precoder matrix for the l-th layer, s-th sub-band, and q-th (q=T+1, . . . QT) future time instant is then given by,

$${P}^{( l )} ( s ) = {P}^{( l )} [ \begin{matrix}{\sum }_{u = 0}^{{U}^{( l )} - 1} {\sum }_{v = 1}^{{N}_{C}^{( u , s , l , p )}} {x}_{1 , u , s}^{( l )} ( v ) {φ}_{1 , u , s}^{( l ) T} ( q , sel ( v ) ) ) ⊗ {b}_{u}^{( l )} \\ {\sum }_{u = 0}^{{U}^{( l )} - 1} {\sum }_{v = 1}^{{N}_{C}^{( u , s , l , p )}} {x}_{2 , u , s}^{( l )} ( v ) {φ}_{2 , u , s}^{( l ) T} ( q , sel ( v ) ) ) ⊗ {b}_{u}^{( l )}\end{matrix} ] .$$

### Method 2:

The Doppler frequency approximation of elements of W₂ across time (T samples) that are basically complex exponentials are replaced by columns of an appropriate basis matrix. Note that these elements are approximated by the conventional delay based DFT across sub-bands in frequency domain. The delay-basis-space precoder for the l-th layer, across S sub-bands and T CSI-RS for both polarizations is,

$${P}^{( l )} = {P}^{( l )} [ \begin{matrix}{\sum }_{u = 0}^{{U}^{( l )} - 1} {\sum }_{d = 0}^{{D}_{u}^{( l )} - 1} {\sum }_{v = 0}^{{N}_{c}^{( u , d , l , 1 )} - 1} {x}_{1 , d , u}^{( l )} ( v ) {d}_{1 , u , d}^{( l )} ⊗ {φ}_{1 , u , d}^{( l ) T} ( ( 1 : T , ) sel ( v ) ) ⊗ {b}_{u}^{( l )} \\ {\sum }_{u = 0}^{{U}^{( l )} - 1} {\sum }_{d = 0}^{{D}_{u}^{( l )} - 1} {\sum }_{v = 0}^{{N}_{c}^{( u , d , l , 2 )} - 1} {x}_{2 , d , u}^{( l )} ( v ) {d}_{2 , u , d}^{( l )} ⊗ {φ}_{2 , u , d}^{( l ) T} ( ( 1 : T , sel ( v ) ) ⊗ {b}_{u}^{( l )}\end{matrix} ]$$

### Here

S is number of sub-bands.
U^{(l)} is the number of beams per polarization for the l-th layer.
N_{C}^{(u,d,l,p)} is the number of basis coefficients/vectors for the l-th layer, d-the delay, p-th polarization and u-th beam, This can vary for some parameters of (u,s,l,p) and be constant for the remaining parameters of (u,s,l,p).
bᵤ^{(l)} is the u-th spatial beam associated with the l-th layer;
φ_{p,u,d}^{(l)T}(1:T,v) is the transpose of the first T elements of the sel(v)-th column of the basis matrix corresponding to d-th delay coefficients across time associated with the l-th layer, u-th spatial beam, and the p-th (p=1,2) polarization of the precoder. This can vary for some parameters of (u,d,l,p) and be constant for the remaining parameters of (u,d,l,p). Likewise, tbhw can vary for some parameters of (u,d,l,p) and be constant for the remaining parameters of (u,d,l,p), if Slepian basis is used.
d_{p,u,d}^{(l)} is S×1 is d-th delay vector (DFT based) associated with p-th polarization and u-th beam.
x_{p,d,u}^{(l)}(v) is the v-th element of the basis coefficient vector associated with the l-th layer, u-th spatial beam, d-th delay and the p-th polarization.
p^{(l)} is a scalar normalisation factor to ensure a certain total transmission power.

The total feedback is the number of basis coefficients across beams, layers, sub-bands and polarizations N_{C}^{(u,d,l,p)} for all u,d,l,p. The PMI report containing the basis coefficients can be used at the base station 104 within the stationarity time of the channel to facilitate predictive multi-user scheduling and/or multi-user precoder matrix prediction. For example, for the precoder matrix prediction, the predicted delay-space-Doppler precoder matrix for the l-th layer, q-th (T+1 QT) future time instant is then given by,

$${P}^{( l )} = {P}^{( l )} [ \begin{matrix}{\sum }_{u = 0}^{{U}^{( l )} - 1} {\sum }_{d = 0}^{{D}_{u}^{( l )} - 1} {\sum }_{v = 0}^{{N}_{c}^{( u , d , l , 1 )} - 1} {x}_{1 , d , u}^{( l )} ( v ) {d}_{1 , u , d}^{( l )} ⊗ {φ}_{1 , u , d}^{( l ) T} ( q , sel ( v ) ) ⊗ {b}_{u}^{( l )} \\ {\sum }_{u = 0}^{{U}^{( l )} - 1} {\sum }_{d = 0}^{{D}_{u}^{( l )} - 1} {\sum }_{v = 0}^{{N}_{c}^{( u , d , l , 2 )} - 1} {x}_{2 , d , u}^{( l )} ( v ) {d}_{2 , u , d}^{( l )} ⊗ {φ}_{2 , u , d}^{( l ) T} ( q , sel ( v ) ) ⊗ {b}_{u}^{( l )}\end{matrix} ]$$

### Other Methods:

In known methods, W₂(:,:,n)=\tilde{W}₂(:,:,n)W_{f}^{H}, where the rows of W_{f}^{H} are from a DFT-basis and is used to compress a row of values corresponding to sub-bands in W₂(:,:,n) to a row of delay values in \tilde{W}₂(:,:,n) for a time instant n. The rows of W_{f}^{H} an be one of Slepian basis, polynomial basis, and DCT sequences for better compression and lesser error across sub-bands than the DFT basis. In known methods, the columns of W₁ are beams based on the DFT basis. The columns can be based on Slepian sequences too. In short, the time, frequency and spatial basis can be a combination of Slepian or DFT/polynomial/DCT basis/any other basis. The Slepian matrix can be calculated if thbw is known. This can be calculated by low-complexity algorithms or an estimate of thbw can be used as well. Thbw can be estimated by taking the FFT of c(n) and analysing it. Slepain matrix lookup tables for a grid of thbw and sequence length QT can also be used.

The channel might have a frequency component, in which case c(n) is obtained after frequency offset compensation and the frequency offset needs to be reported to the base station 104 as well. Embodiments herein can use a Slepian based prediction. Those skilled in art can extend these ideas in a straight forward way to port selection codebook, codebooks for multi-panel/multiple transmission-reception-points (TRPs) with and without Doppler etc.

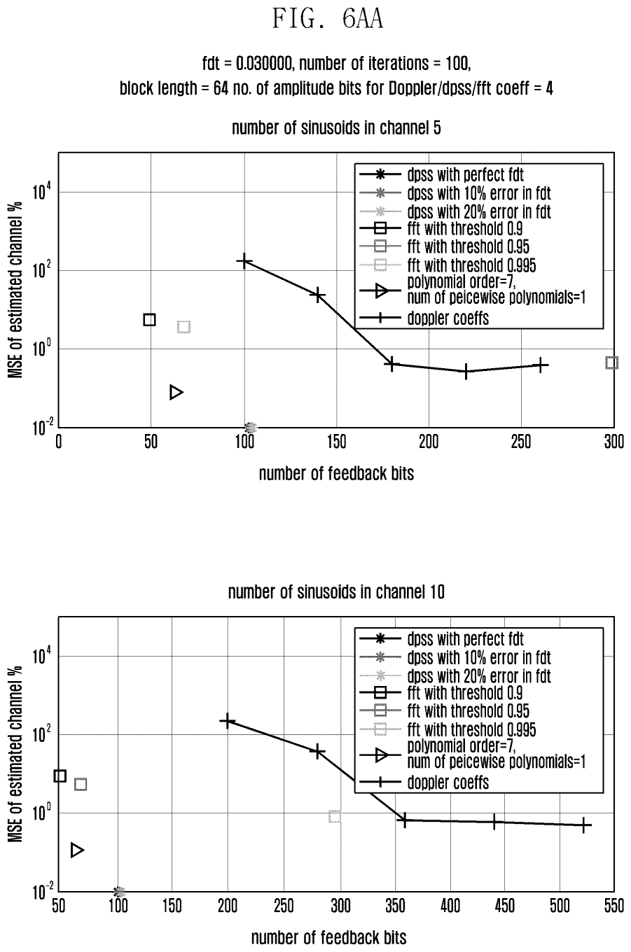

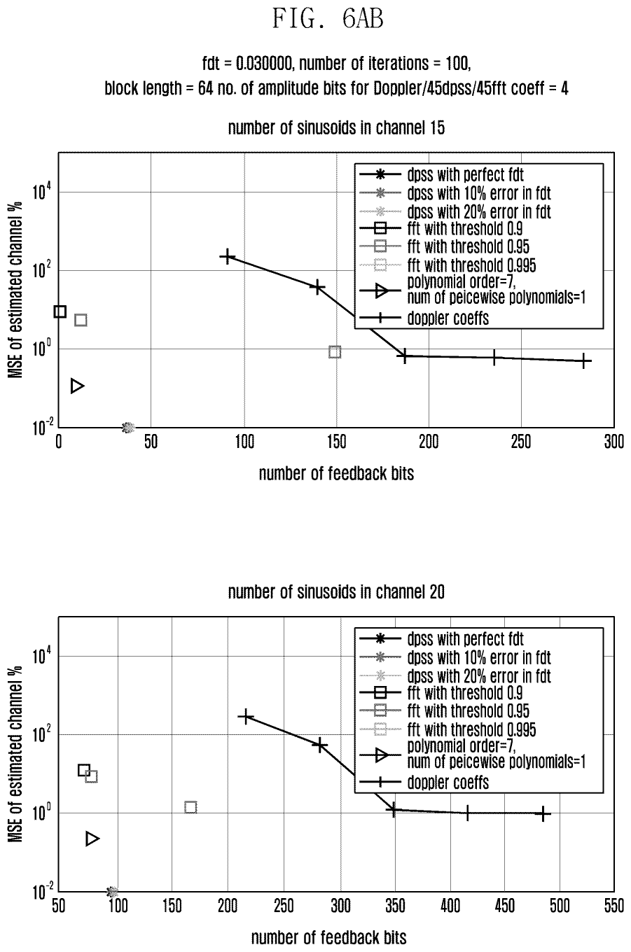

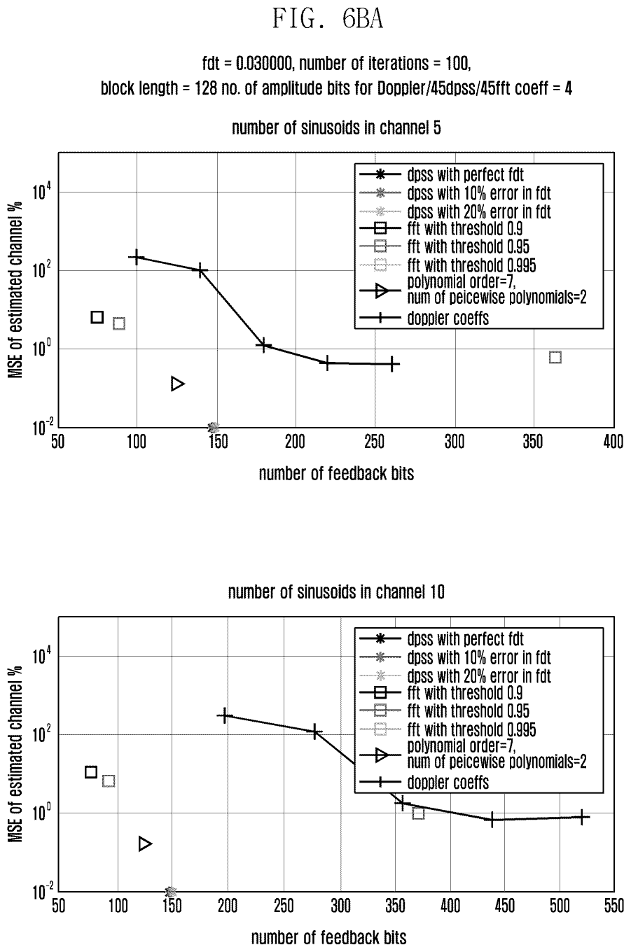

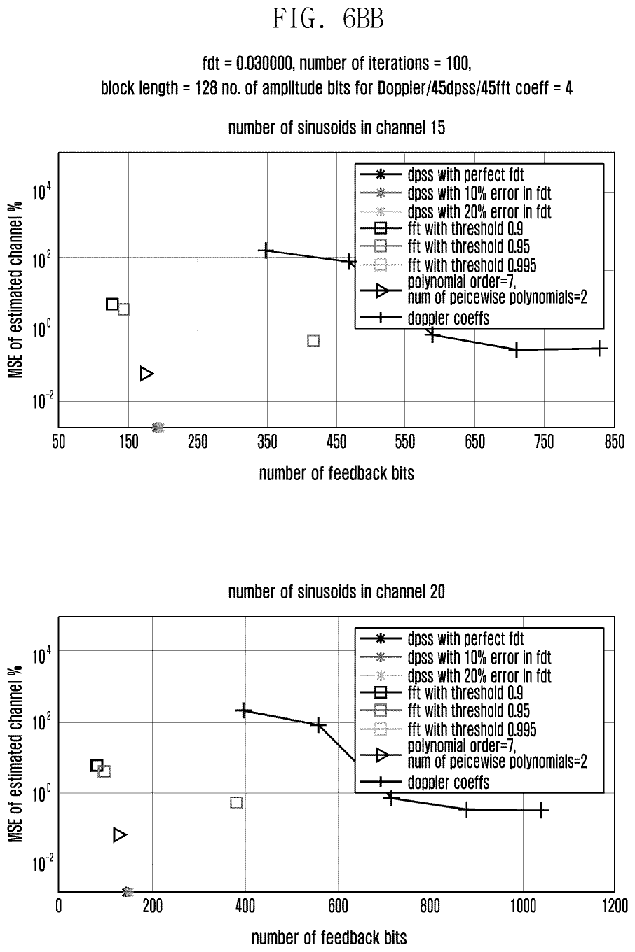

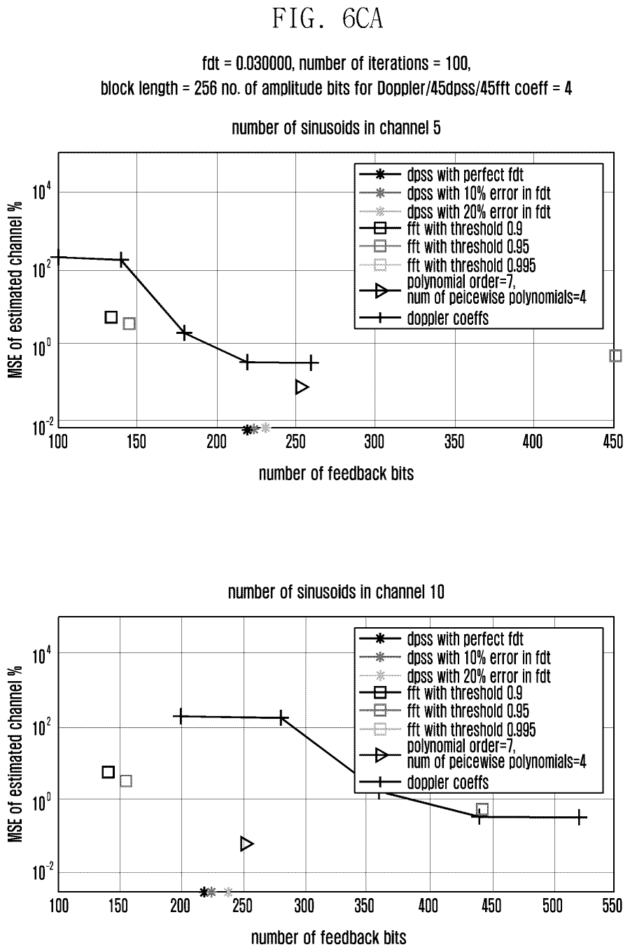

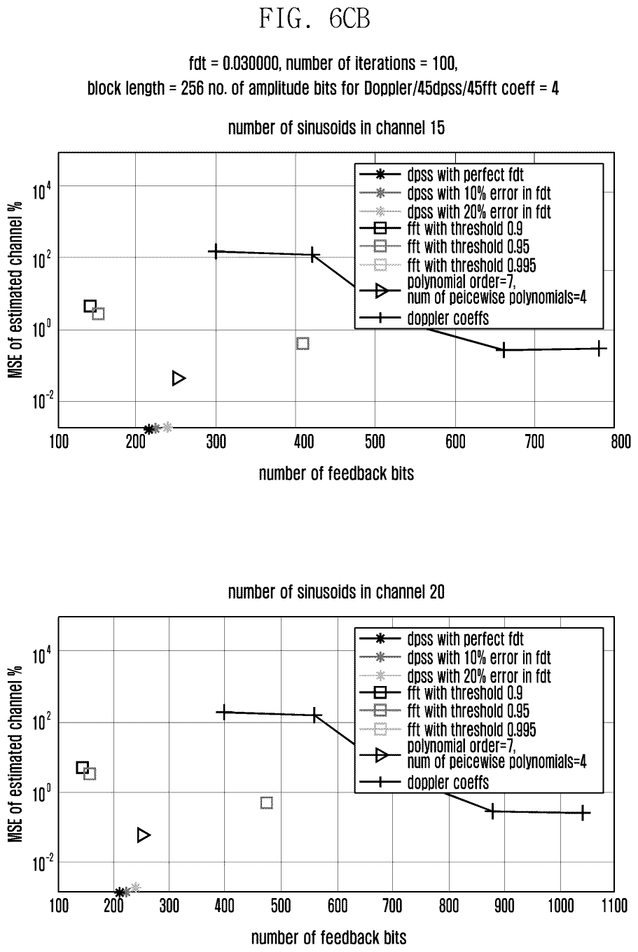

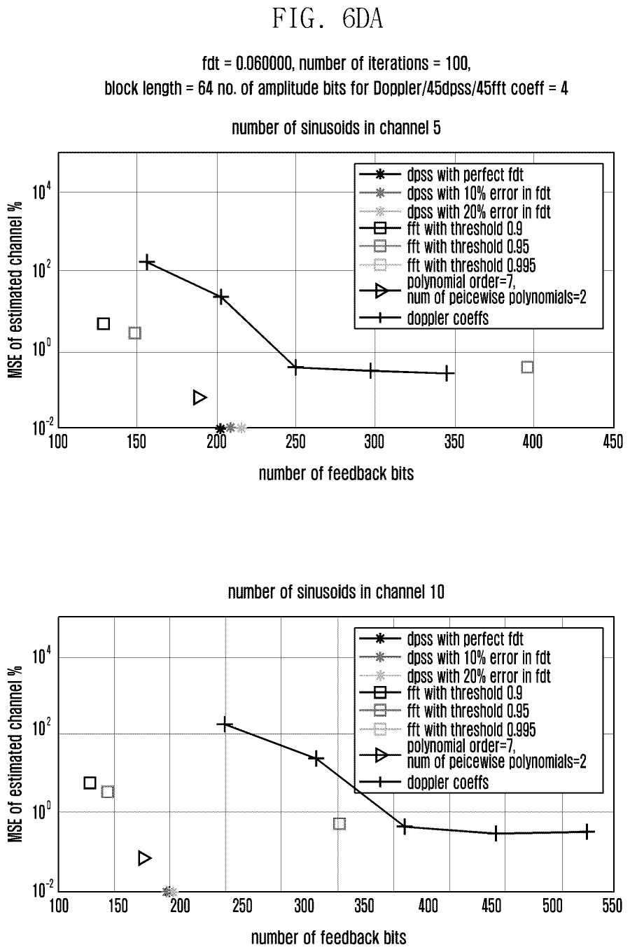

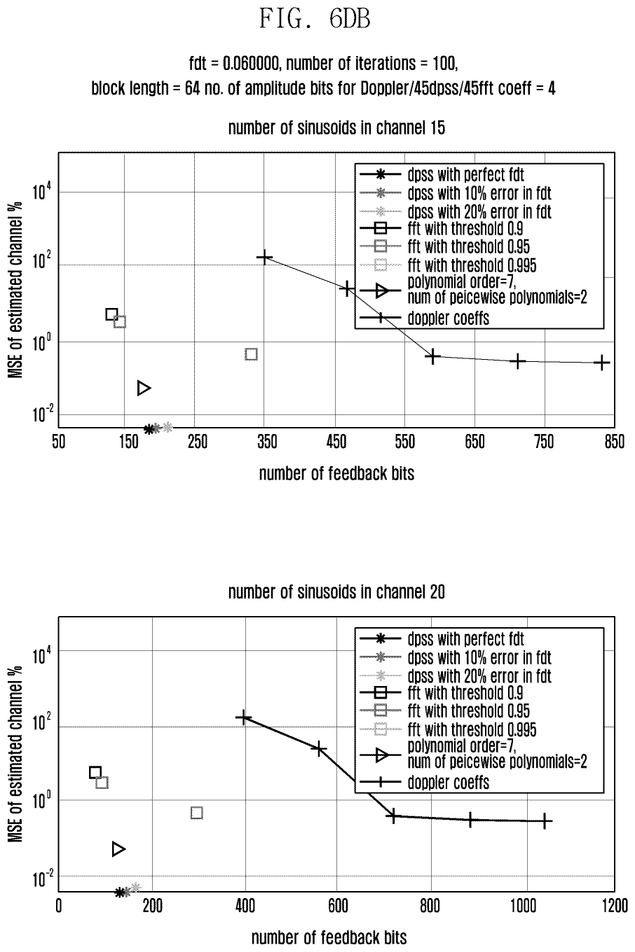

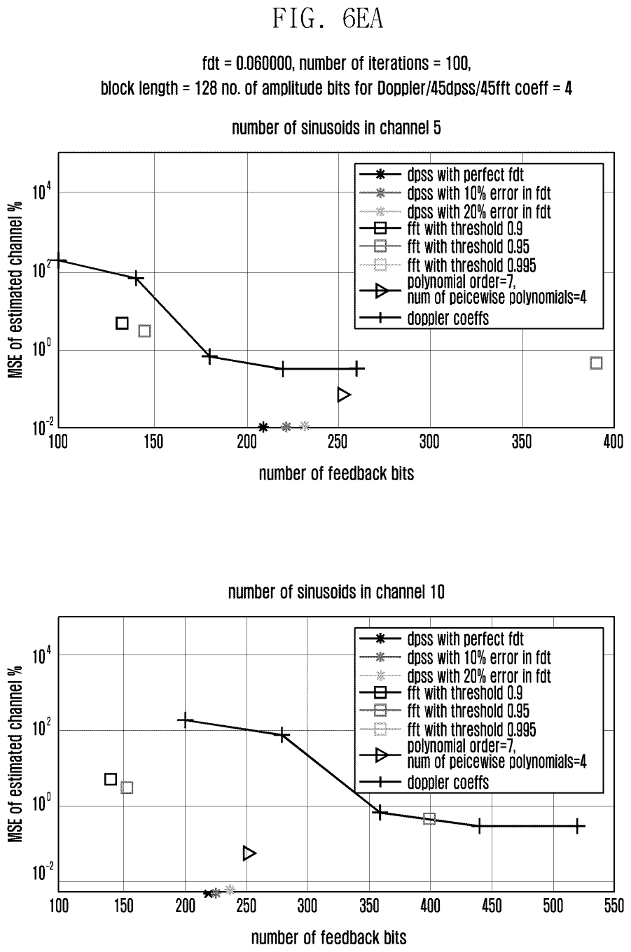

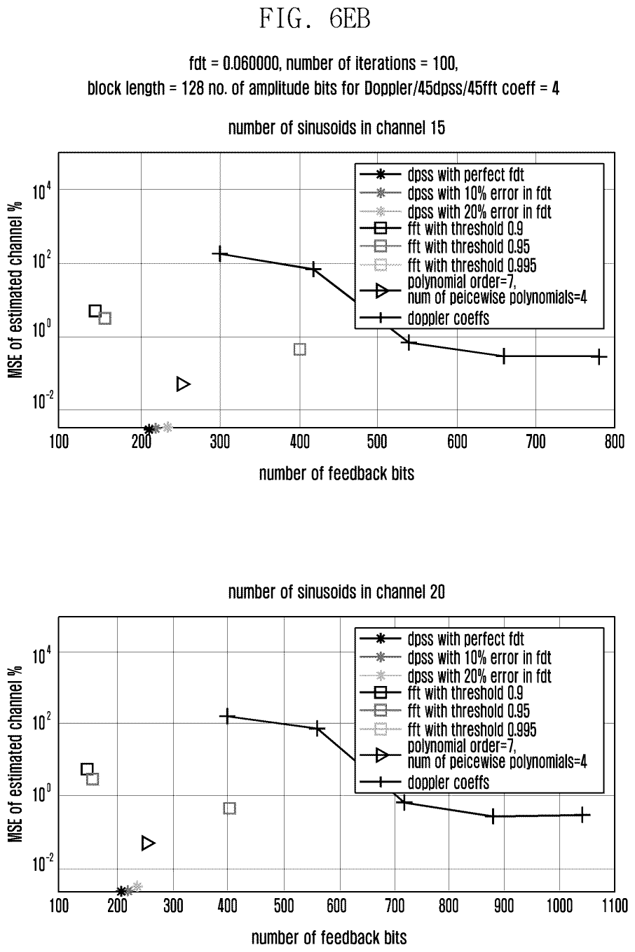

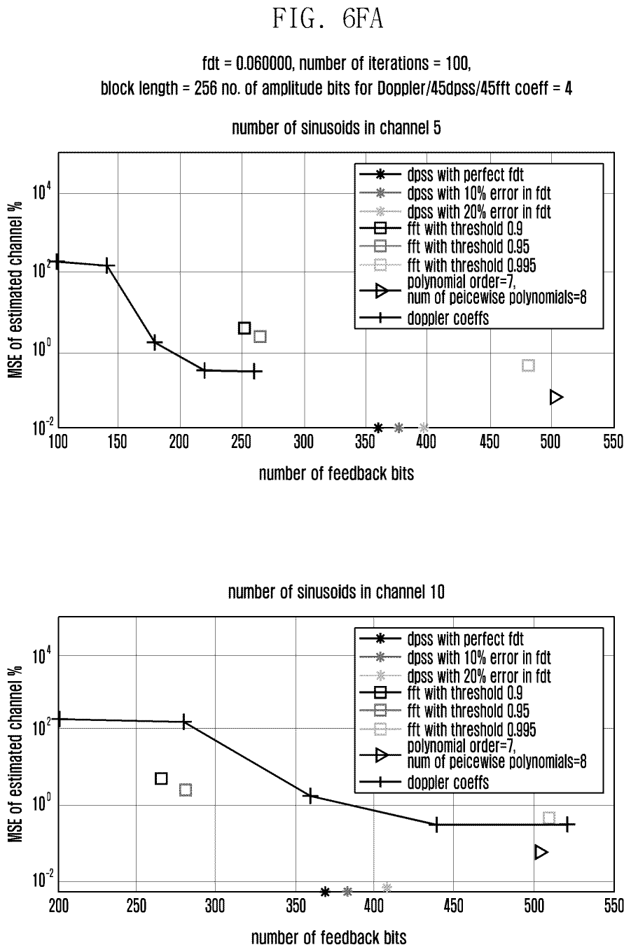

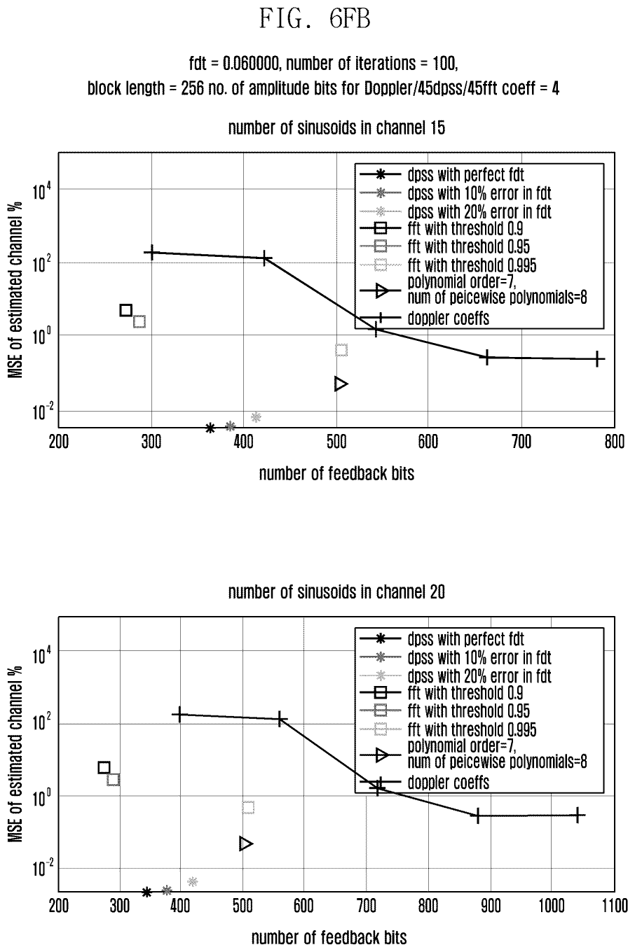

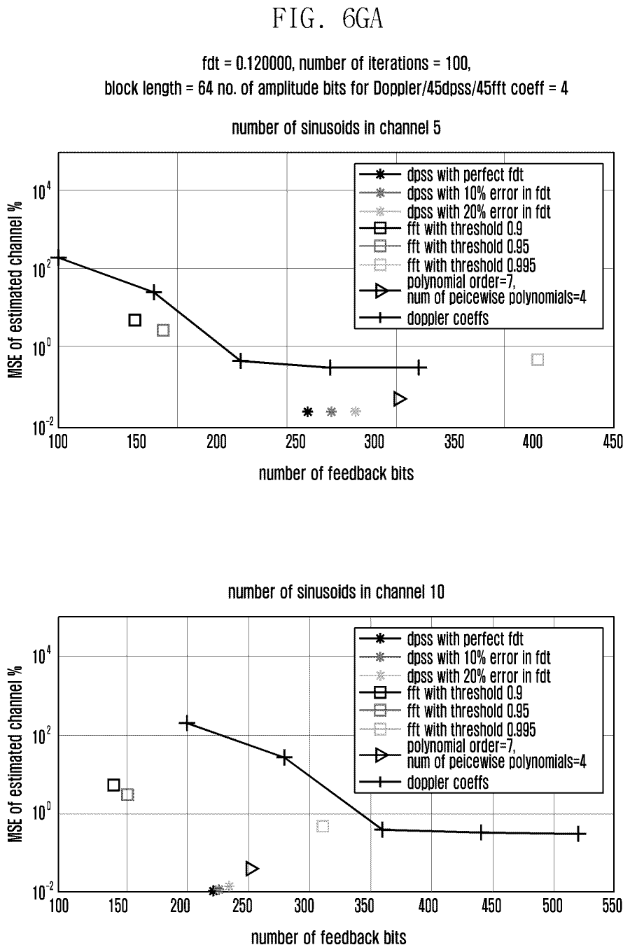

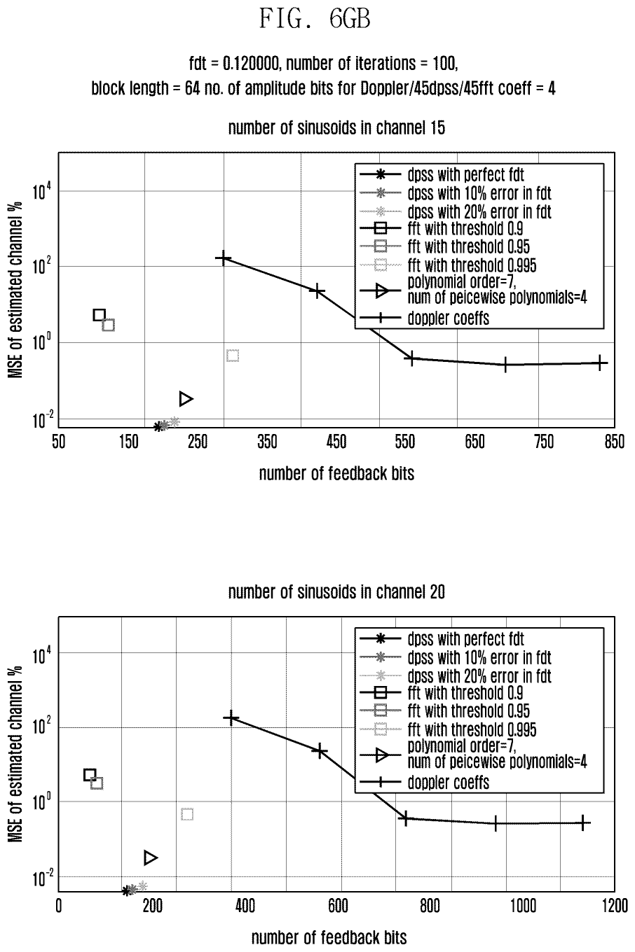

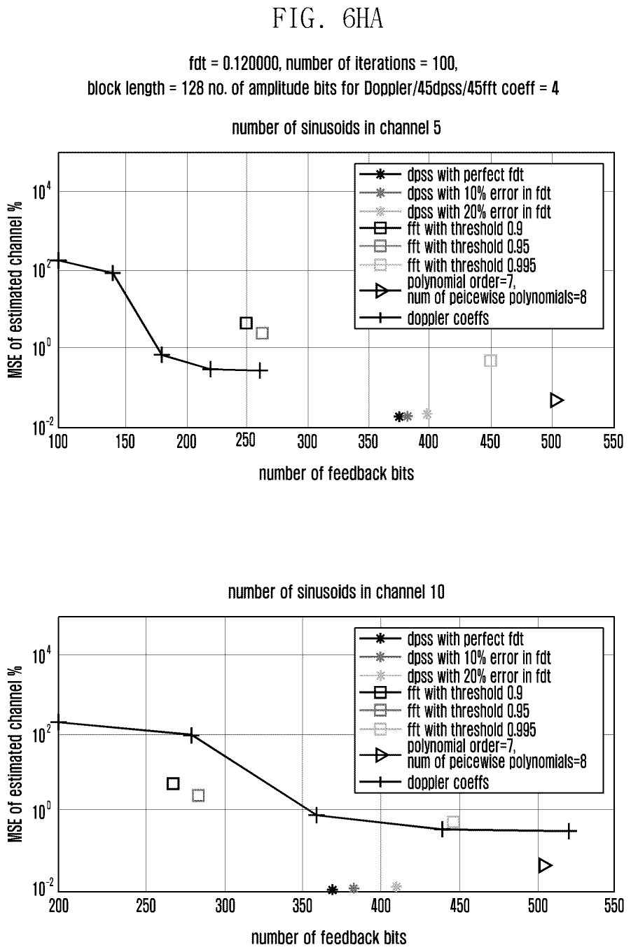

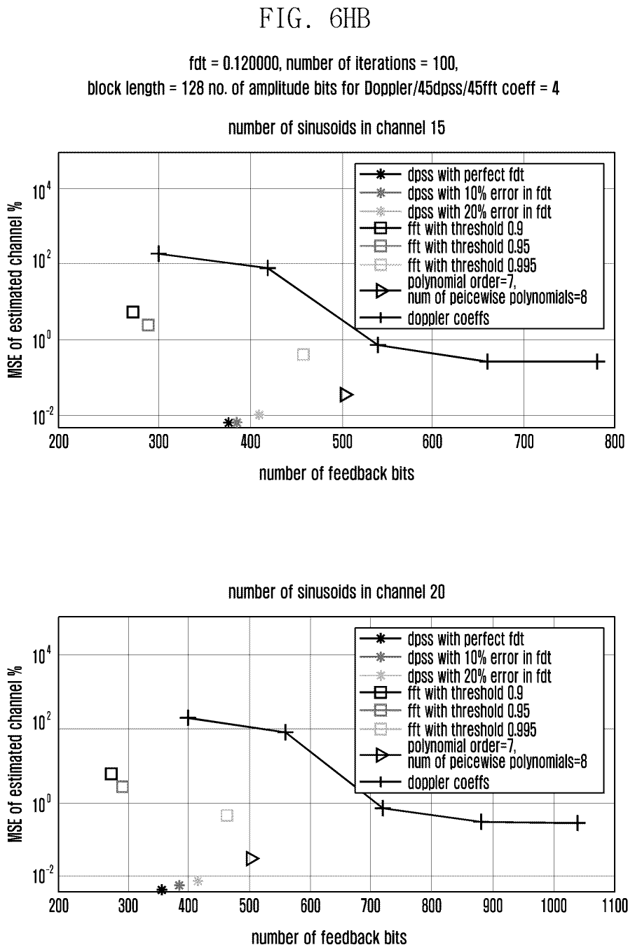

In an embodiment herein, simulation results are depicted in FIGS. 6A-6I. A channel is simulated with a number of sinusoids for a given sub-band. Here, block length means the number of samples in both observation and prediction windows. The complex exponentials lie between-fdt and fdt, where fdt is the digital frequency (between −0.5 and 0.5). Amplitude bits for all methods are quantized to 4 bits. The location of complex exponential frequency is quantized between 4 to 20 bits in steps of 4. The x-axis denotes the total feedback. For Slepain/DFT basis SEL is selected based on maximum energy in basis coefficients while for polynomial, P columns (or all columns of the basis matrix) corresponding to order of polynomial are selected. The results are presented herein with 10% and 20% error in fdt. For these methods, the number of Slepian coefficients corresponding to the columns of the Slepian matrix is such that more than 99.5% of energy is present in the N_{c} coefficients. Energy of all Slepian coefficients (if channel is projected across all columns of the Slepian matrix) is assumed at 100%. As Slepian basis method is known to be better than the FFT basis method, the FFT basis method for three thresholds is presented. For the FFT basis method, the zeroth bin and next num bins along with num bins at the end are low frequency bins. num is chosen such that energy in these bins is a threshold times the total energy in all FFT bins. The polynomial basis results are also depicted.

In an embodiment herein, the basis selection module 204 can project the predicted channel on to the oversampled DFT basis. In an embodiment herein, the oversampled DFT basis provides the CSI feedback using a differential reporting of location and values of Doppler frequency components, corresponding to the channel in the sub-band. In an embodiment herein, the oversampled DFT basis provides the CSI feedback using the differential reporting of location and values of Doppler frequency components, corresponding to the channel in the delay domain. The differential reporting is the difference with respect to a reference reported along with the reference.

In general, the Doppler frequency components need high resolution. A sample channel is generated as,

$$c ( n ) = {\sum }_{z = 1}^{Z} {a}_{Z} {e}^{j 2 π {f}_{z} n} , n = 0 , … QT - 1$$

Here, c(n) can be element of a channel matrix across time or elements of W₂, \tilde{W}₂ for a given beam and sub-band/delay across time. f_{z} is the normalized Doppler spread, i.e., product of Doppler frequency (Hz) and T, sampling period of CSI-RS (sec). The a_{z} is generated such that,

E|a_{z}|²=1,

and

|f_{z}|<fdt

The quantization is as follows for feedback of Doppler coefficients for any beam/sub-band across time (f_{z}). Integer part is 2 bits. Fractional part is four to 20 in steps of four bits.

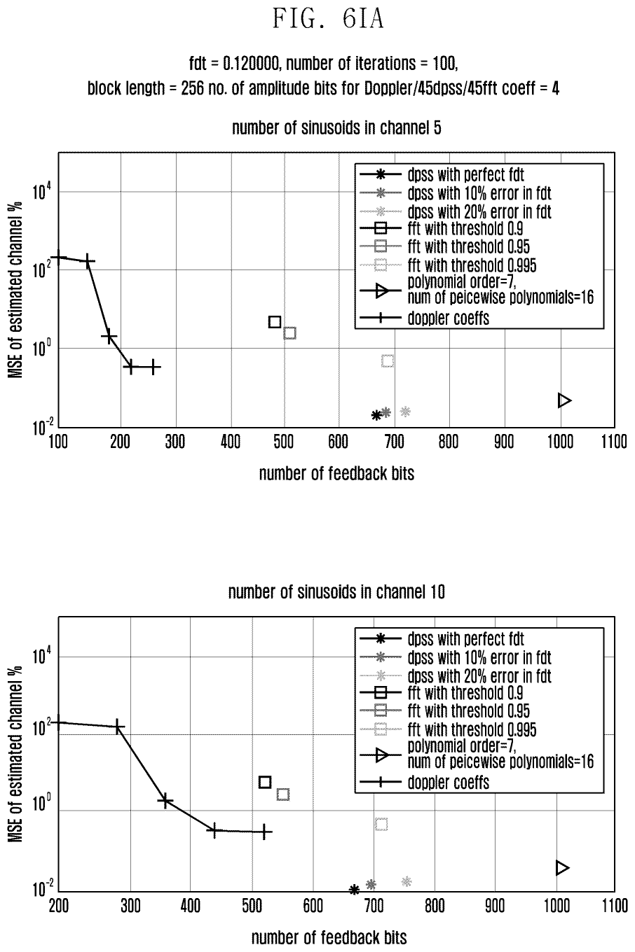

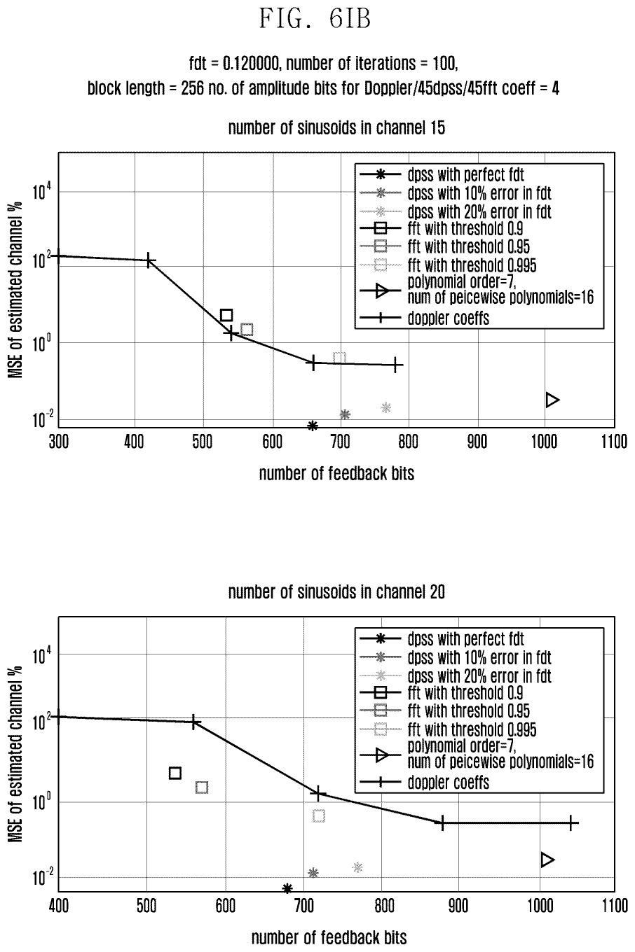

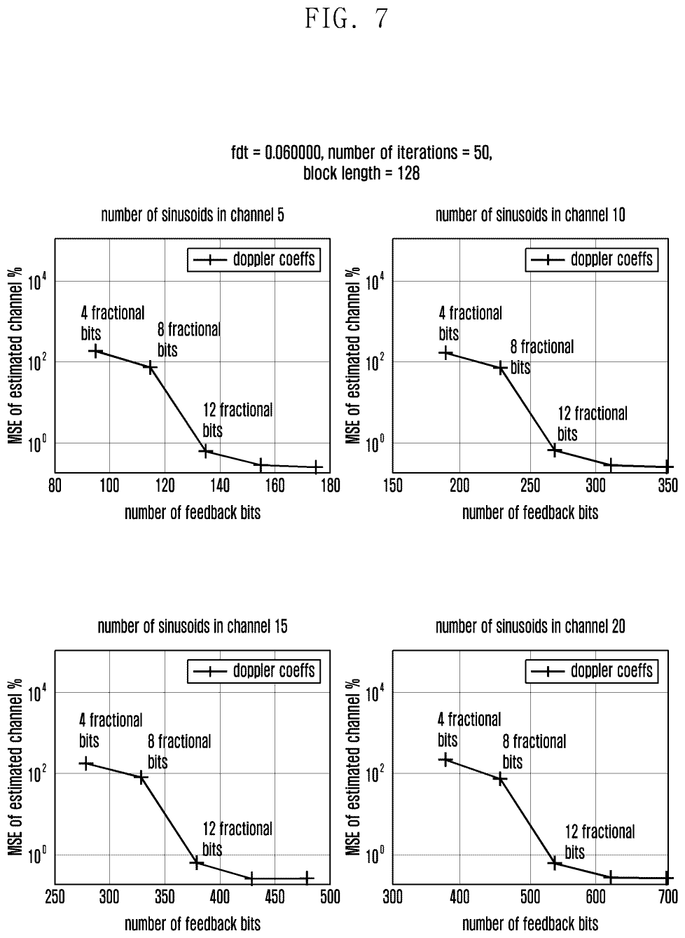

FIG. 7 depicts variation in x-axis with quantization for feedback of Doppler coefficients. As can be seen we need at least 12 fractional bits to feedback f_{z}. If the observation window OW is say, of length 128 samples, the quantized version of f_{z} that corresponds to a column of oversampled DFT, may mean that an oversampling factor of 32 is needed.

The basic operation involves an observation window (OW) of N1 samples followed by a prediction window (PW) of N2 samples. The OW has a CSI burst of N1 samples. The PW can/cannot have the CSI burst (optional). Using any of the methods, some Doppler related feedback about Doppler coefficients corresponding to beam/sub-band across time is sent by the UE to the base station at the end of the OW, using which the necessary feedback values in the PW can be predicted or the feedback in the PW can be reduced.

For example, the differential reporting of the Doppler frequency components (f_{z} v) across beams, sub-bands/delays and so on is disclosed. The elements of w₂ vector (or even the channel vector) across time (row are elements as per existing releases, columns are time) for computing the Doppler shift i.e.,

$$v / c * deltafc * T = 5.5 e - 4$$

In the above equation, v=30 km/hr be the speed, c=3e8 speed of light, deltafc=3.96 MHz, difference in 22 resource blocks (RBs) at 15 KHz sub-carrier spacing, sampling time for CSI-RS=5 ms, and Oversampled DFT bin resolution (@12 bits)=1/4096=2.44 e-4;

So, there is a change of 3 bins across 22 RBs. Table 1 provides indices of a column of oversampled DFTs, corresponding to Doppler frequency, for different UE speeds and number of RBs.

TABLE 1

| UE speed | Number of RBs | Doppler shift |
|---|---|---|
| (kmph) | separation | for 4096-pf DFT (in bins) |
| 30 | 22 | 3 |
| 30 | 270 | 28 |
| 120 | 10 | 4 |
| 120 | 25 | 11 |
| 120 | 270 | 111 |

Therefore, across 22 RBs, the reported column of the oversampled DFT can shift by three or in practice it can shift by 10-20 bins. Thus, across sub-bands, feedback 12 bits is not needed, only one or two bits or a few bits for Doppler frequency difference w.r.t reference RB and feedback can be reduced.

The differential reporting can be carried out for a dominant Doppler frequency value and other Doppler frequency values across beams/sub-bands. For example, in oversampled DFT, one Doppler frequency (DF1) could be the 273^{rd} column of oversampled 1024-DFT, the same Doppler frequency (DF2) across a sub-band 22 RBs away may be 274^{th} columns and therefore two bits (with a sign bit) for DF2 with respect to DF1 can be reported, instead of 12 bits each for DF1 and DF2.

Thus, the calculated feedback rate is reduced when compared with conventional predefined feedback rate and saves the feedback overhead.

In an embodiment herein, the Doppler frequency components W₂ (for a given sub-band and beam across time) or \tilde{W}₂ (for a given delay and beam across time) or even the channel matrix (across sub-bands) can be reported as follows. Absolute location of Doppler frequency components for sub-band s1, relative location of Doppler frequency components for sub-bad s2 with respect to s1, relative location for sub-band s3 with respect to s2 and so on. The differential reporting of the Doppler frequency components can be carried out for the CSI feedback. The 3GPP message CSI-Report-configuration->-report-quantity can be used for this purpose.

In an embodiment herein, the Doppler frequency components map to basis vectors, as an example, columns of non-orthogonal oversampled DFT. Basis vectors can be restricted within a window or a selection vector sel of the basis vectors can be restricted. For example basis vectors belong to {Minit:Mint+K−1}, K=window size, Minit=initial index of the window. Or, in general, the window can be {Minit+delta*(K−1)}, delta is an offset/separation between two consecutive indices.

If the above Doppler frequency components map with respect to basis vectors is for sub-band s1, for any other sub-band s2 Mint can move slightly to the left or right. That is Mint for sub-band s2 can be Mint for sub-band s1+/−delta1, a small value. Likewise for delays and beams. Likewise sel can vary across sub-bands by a small amount delta1.

Each of Minit, K, and delta, delta1 can be fixed, configured (RRC), or reported by the UE 102 or by the base station 104 via DCI or MAC-CE. Likewise, a combination of two or more of Minit, K, and delta can be fixed, configured (RRC), or reported by the UE 102.

Just like Doppler frequency components were reported differentially across sub-bands/delays and beams, basis coefficients can also reported differentially.

Note that N4 reports (corresponding to channels) can be compressed and sent in one report as below. The N4 reports corresponding to N4 channel instances can be called as CSI-Report-Window (CSIRW). In what follows, even though W₂ matrix is explained, it holds good for channel matrix or W₂ as well. Let t be the beginning report in the CSIRW and t+N4−1 be the last report in CSIRW. Now y_{b,s}=W₂(b,s,t:t+N₄−1) can be compressed which is for beam b and sub-band s. For y_{b,s}=ø_{b,s}x_{b,s} where ø_{b,s} is the basis matrix and X_{b,s} are the basis coefficients, this can be compressed by just sending X_{b,s}

The choice for ø_{b,s} are:
Non-orthogonal oversampled DFT: This corresponds to Doppler frequency components mapped to appropriate columns of ø_{b,s} The selected indices are reported in a differential manner as previously described. Additionally X_{b,s} must be reported as well.
Orthogonal DFT, Slepain, DCT, Polynomial basis and so on: No need to report the basis matrix ø_{b,s} only report X_{b,s}.

Just as indices/columns of ø_{b,s} are differentially reported, X_{b,s} can also differentially reported. That is X_{b1,s1} can be differentially reported with respect to X_{b2,s2} etc. Alternately, X_{b,±a,s±c} can be differentially reported with respect to X_{b,s} where b±a represent neighbours of beam b and s±c are neighbours of sub-band s.

The CSIRW can have two types of estimates. One derived from received CSI-RS and the other based on prediction/interpolation or extrapolation of the former.

Prediction can be based on the Doppler frequency components or linear prediction (AR coefficients, Yule-Walker equation Levinson Durbin alg, etc.) or non-linear prediction based on neural network models like RNN/LSTM. The report that sent can be before/after or in the middle of the CSIRW.

In general, the base station 104 may not know when to send CSI-RS in the OW. That is, the base station 104 may not know the lengths of the OW and the PW. However, the Doppler related feedback from the UE 102 to the base station 104 can comprise, but not limited to time domain correlation across sub-carriers, time-frequency domain correlation, Doppler spread/shift, multipath information etc. This can be used by the base station 104 to determine the lengths of the OW, the PW and when to trigger the same.

The CSI reports can have information about W₁ (spatial basis), W₂ or \tilde{W}₂ (FD basis) and W_{F}. Usually over OW and PW, only elements of W₂ or \tilde{W}₂ may change and W₁ (spatial basis), W_{F} may remain constant. If there is a change of W₁ (spatial basis), W_{F} the UE 102 reports the same to the base station 104 and this can be used by the base station 104 to trigger a new set of OW and PW. That is the base station 104 assumes since W₁ has changed and it needs to trigger a new OW/PW.

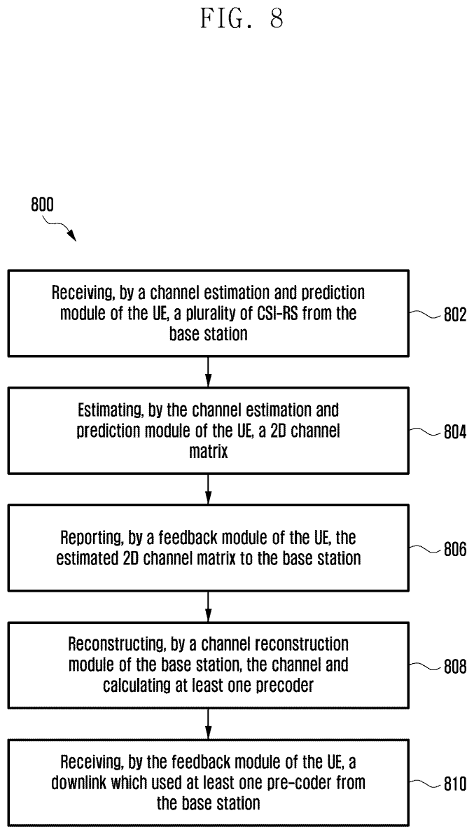

FIG. 8 depicts a method 800 for using Slepian sequences for spatial domain (SD) basis for codebook based enhancements at the base station transmitter in wireless communication networks. The method 800 includes receiving, by the channel estimation and prediction module 202 of the UE 102, a plurality of CSI-RS from the base station 104 across a plurality of sub-bands, as depicted in step 802. The method 800 includes estimating, by the channel estimation and prediction module 202 of the UE 102, a two-dimensional (2D) channel matrix for each receiver and each sub-band in the UE 102 and all transmit antennas in the base station 104 that has a 2D layout, as depicted in step 804.

Thereafter, the method 800 includes reporting, by the feedback module 206 of the UE 102, the estimated 2D channel matrix to the base station 104 for each receiver and each sub-band in the UE 102, as depicted in step 806. The method 800 includes reconstructing, by the channel reconstruction module 304 of the base station 104, at least one channel for the reported 2D channel matrix and calculating at least one precoder based on the reconstructed at least one channel for a downlink transmission, as depicted in step 808. Subsequently, the method 800 includes receiving, by the feedback module 206 of the UE 102, the downlink which used the pre-coder based on the reconstructed channel from the base station 104, as depicted in step 810.

The various actions in method 800 may be performed in the order presented, in a different order or simultaneously. Further, in some embodiments, some actions listed in FIG. 8 may be omitted.

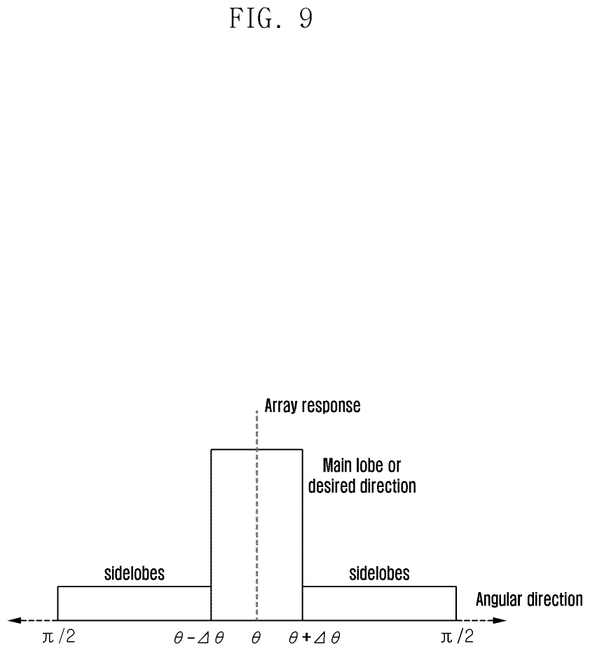

FIG. 9 depicts a desired beamforming array response of a uniform linear array. Consider a uniform linear array (ULA). The beamformer weights W such that w^{H}w=1, and maximizes the energy in main lobe given by the Slepian sequence. The beamformer weights W is designed for a criterion of minimum side lobe leakage and is shown to be a Slepian sequence. This can be useful for network energy savings, lesser feedback (in terms of L or length W₂ W₂ if W₁ is composed of Slepian basis instead of the oversampled DFT basis). Let C_{θ} be the steering vector of 1D-ULA in direction θ. Beamformer weights W such that w^{H}w=1. The array F(θ)=W^{H}Cθ. F²(θ) is maximized between θ−Δθ, θ+Δθ to result in maximizing ∫_{ø=øΔø}^{ø-Δø}∫_{θ=θ+Δθ}^{θ-Δθ}F²(θ)dθdø. 2Δøw^{H}Aw are maximized, where A=∫_{θ=ƒ+Δθ}^{θ-Δθ}c_{θ}c_{θ}^{H}dθ. The solution to the above equation is the Slepian sequence.

In an embodiment herein, the Slepian beams can be designed to maximize energy in the main lobe of 2Δθ around θ called as main lobe bandwidth (MLBW). In an embodiment herein, the Slepian beams can be designed to maximize energy in the main lobe of 2Δθ round θ called as mainlobe bandwidth (MLBW) in 1D array. However, other techniques can be extended to other arrays, such as 2D arrays. Alternatively, for 2D array, embodiments herein can individually design the optimal beamformer in horizontal and vertical directions and perform a kronecker product of the two.

For a given DFT beam, embodiments herein can design a corresponding Slepian beam that has maximum energy in the same direction. If the DFT beam has more than one maxima, embodiments herein can design a beam which is sum of weighted Slepian beams, each of which corresponds to a maxima in the DFT beam.

A beam with a main lobe is analogous to a time domain signal that is bandlimited/band pass. Therefore, design of Slepian beams for Clustered Delay Line (CDL) channels are explained herein with respect to simple band pass signals, which can be further extended to CDL channels.

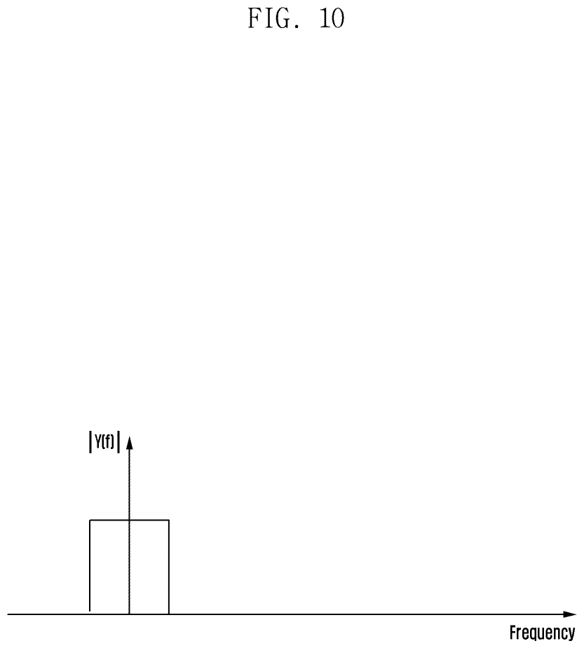

FIG. 10 depicts low pass time domain signals, wherein a low pass signal can be modelled with only a few basis vectors/coefficients. Examples of the basis can be, but not limited to, the Slepian basis, the polynomial basis, the DFT basis, DCT basis, or any other suitable basis.

FIGS. 11A and 11B depict examples of low pass/band pass time domain signals. Ad-vantages of compressed representation of a low pass signal using a few basis vectors/coefficients can be extended to bandlimited/band pass signal also, by down conversion by an exponential.

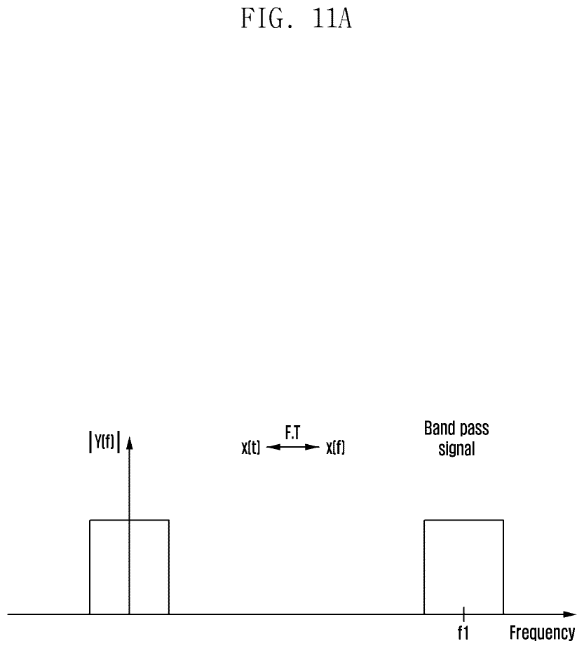

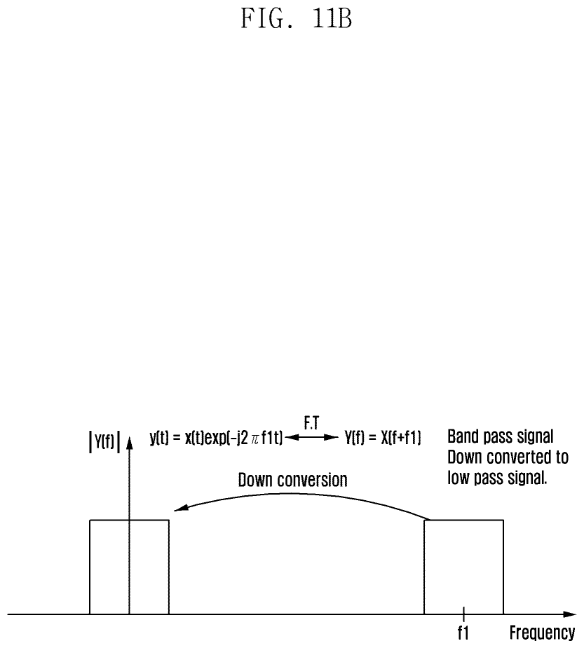

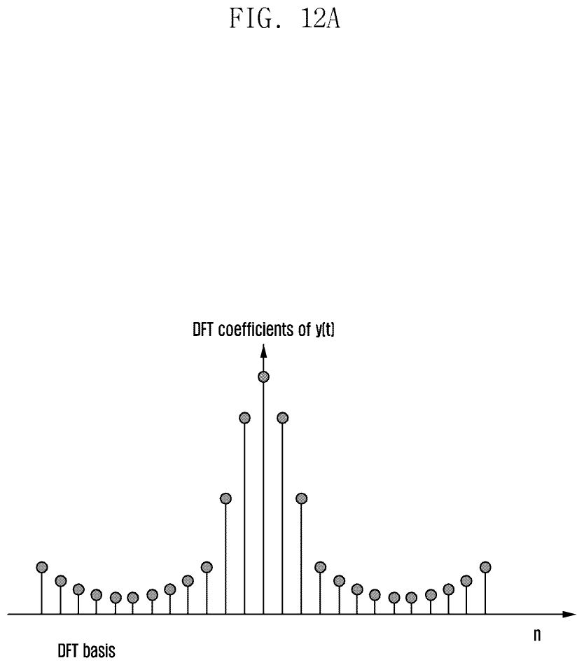

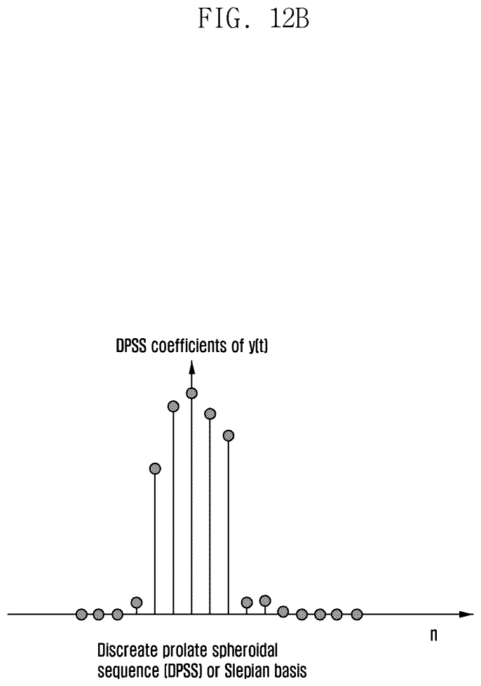

FIGS. 12A and 12B depict examples of basis coefficients of the low pass signal. The number of coefficients for Slepian basis is much lesser than the DFT basis and reconstruction error is much lesser for the Slepian basis compared to the DFT basis.

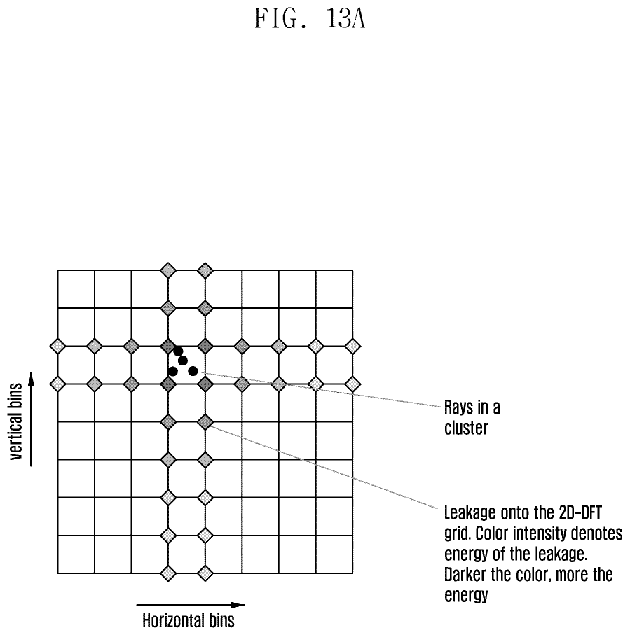

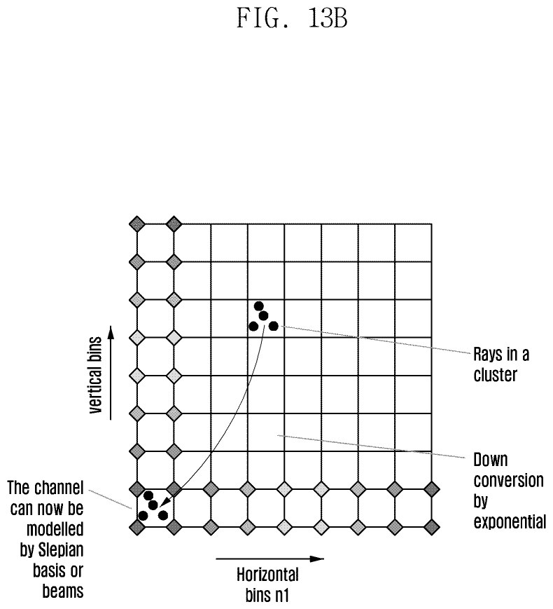

FIGS. 13A and 13B depict the 2D FFT for the CDL channel that has only one cluster and it's down converted version. Each cluster can be exponentially down converted to 2D-low pass and modelled by a basis like Slepian or other basis like DCT, polynomial etc. The exponential value with an up conversion and Slepian basis coefficients are a good approximation to the channel denoted by the rays of the cluster. Each cluster may correspond to the Slepian basis coefficients and exponential up conversion value.

Assume there are N_{R} vertical antennas and N_{T} horizontal transmit antennas (antennas or referred to as antenna ports) and the 2D channel of all transmit antennas in any sub-band for a given receiver in UE is denoted by H of dimension N_{R}×N_{T}. The channel can be denoted as

H=ΣₗaₗTₗ

,where a ray is indexed by l (a channel has many clusters and each cluster has many rays). The transmitted steering vector or array response is denoted by N_{R}×N_{T} matrix Tₗ and H is conjugate transpose, aₗ is the gain of the ray l. Without loss of generality, assume a single cluster of rays whose 2D-FFT has a peak around m,n, where 0≤m≤N_{R}−1 and 0≤n≤N_{T}−1. The down converted channel can be approximated as D⊙H≈Σ_{m∈V}_{ₗ}Σ_{n∈V}_{_{H}}ø_{m,n}^{(b)}x_{m,n}^{(b)}, where D is down conversion matrix, whose (l,k)th element is given as

$$D ( l , k ) = {e}^{- j 2 {π ( \frac{m l}{{N}_{R}} + \frac{n k}{{N}_{T}} )}^{’}}$$

ø is a 2D basis matrix, b is the basis choice like Slepian, polynomial, DFT, oversampled DFT, KH Transform, DCT or any other basis, x is the basis coefficient, m, n are basis indices in two dimensions, V_{I}, V_{H} and are the sets of two basis indices.

In an embodiment herein, V_{I}, V_{H} can be low pass frequencies/indices. V_{I} spans from a, . . . ,0 and N_{R}, . . . N_{R}−b. V_{H} spans from P, . . . ,0 and N_{T}, . . . N_{T}−Q.

In an embodiment herein, the 2D basis matrix can be written as product of two

ø_{m,n}^{(b)}=øₘ^{(b,NR)}øₙ^{(b,NT)T}

where T is transpose operation, where ø_{m,n}^{(b)} is N_{R}×N_{T}, øₘ^{(b,NR)} is N_{R}×1, øₙ^{(b,NT)} is N_{R}×1.

Examples of øₘ^{(b,N)} are disclosed herein. If basis b is DFT, then øₘ^{(b,N)}=m^{th} olumn of the DFT matrix of size N×N If basis is Slepian, øₘ^{(b,N)} is the m^{th} Slepian sequence. This can be characterized by a parameter, half-bandwidth product. If basis is polynomial, øₘ^{(b,N)} is the mth column of matrix, then

$$A = {[ \begin{matrix}1 & 1 & … & 1 \\ ⋮ & ⋮ & … & ⋮ \\ 1 & {N}^{2} & … & {N}^{N - 1}\end{matrix} ]}^{.}$$

There are three dimensions such as spatial, frequency, time. Any basis can model one or more joint dimensions. Examples of the basis can be, but not limited to, Slepian, DFT, oversampled DFT, polynomial, DCT, Karhunen-Love transform etc. Examples of the joint dimensions can be, but not limited to, space-delay (delay dimension is FFT of frequency dimension), delay-Doppler (Doppler dimension is FFT of time dimension), angle-delay-Doppler dimension (angle dimension is FFT of spatial dimension), and so on. The antennas can be non-uniform. Examples of the antennas can be multi-panel. The distance between the panels can be different from distance between antennas of panel, or some ports can be switched off in the antenna panel.

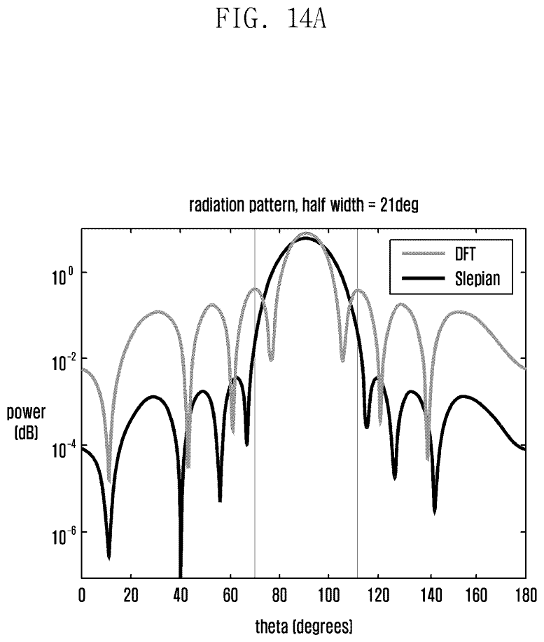

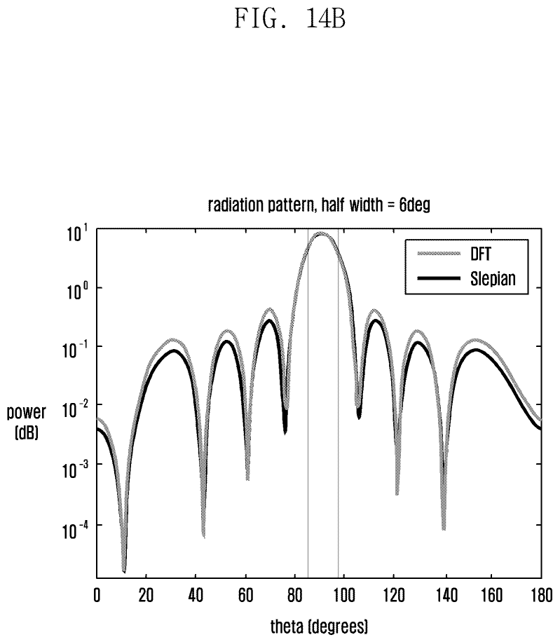

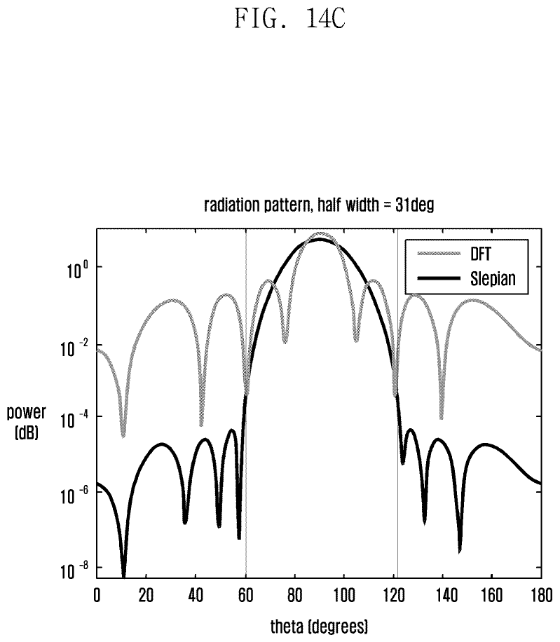

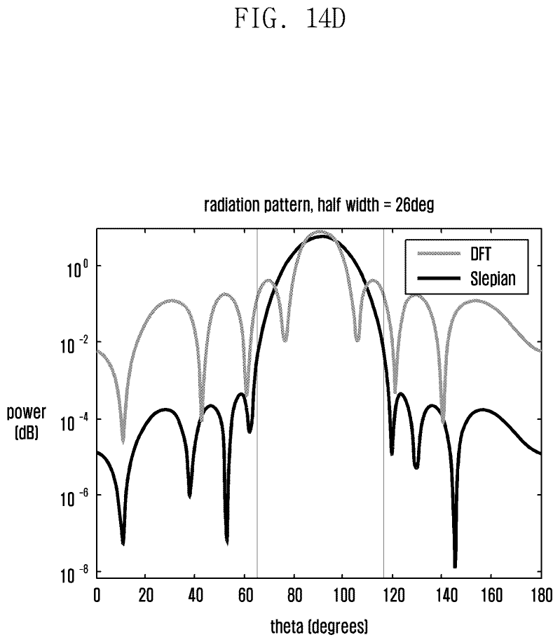

FIGS. 14A-14E depict example radiation patterns of DFT and Slepian beams for various half widths. A significant reduction in side lobes can be observed. Therefore, a reduction in inter-user interference can be obtained. Further, it can be seen that this is a more energy efficient scheme when compared to DFT.

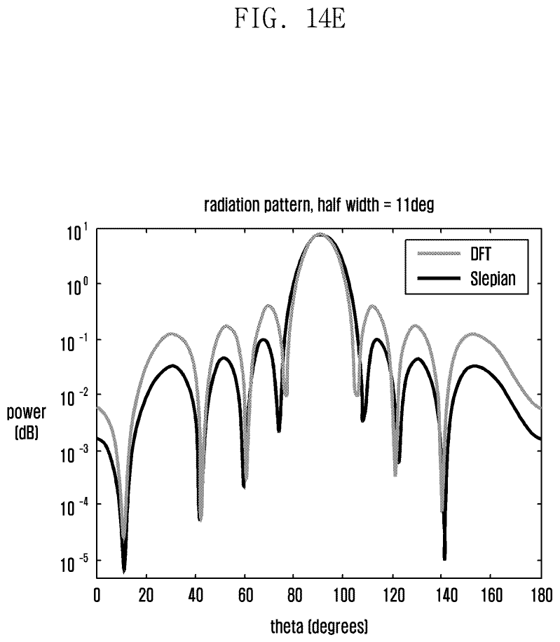

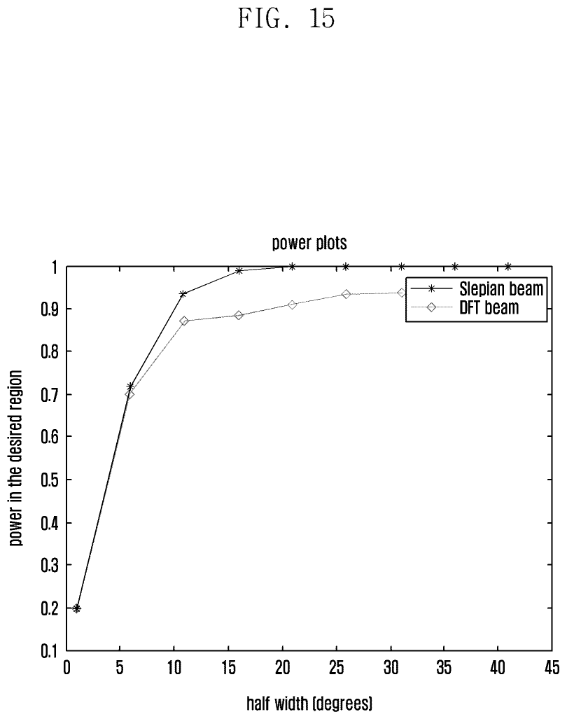

FIG. 15 depicts an example plot of the percentage of power in the desired region. Here, [-Half width, Half width]is the desired region. The percentage of power in the desired region is more when a Slepian beam is used, when compared to the DFT beam.

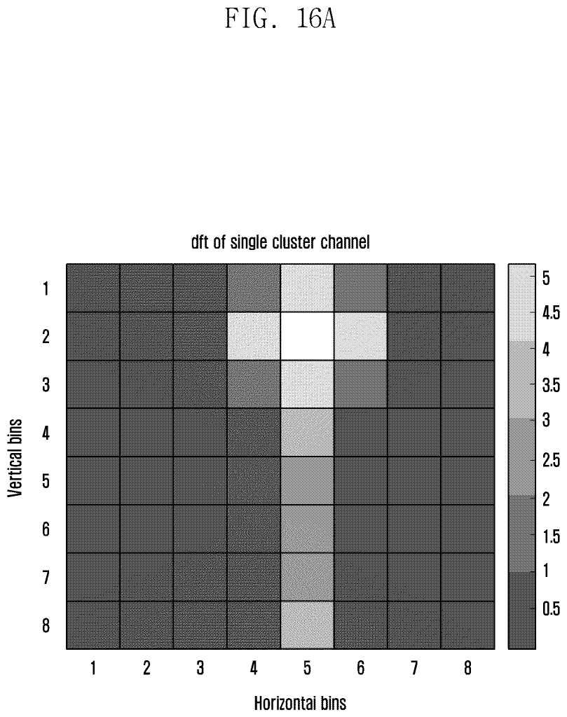

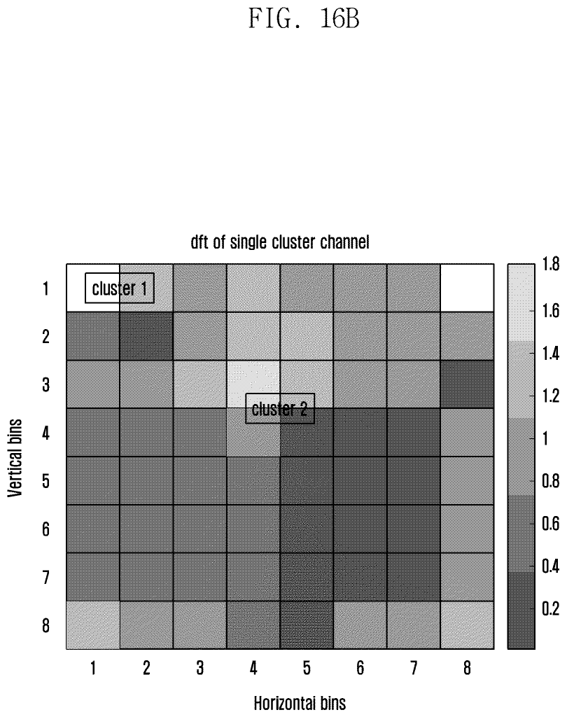

FIGS. 16A and 16B depict 2D FFTs of a single cluster CDL channel and two cluster CDL channel respectively. It can be seen that each cluster has a local maxima in the 2D DFT grid.

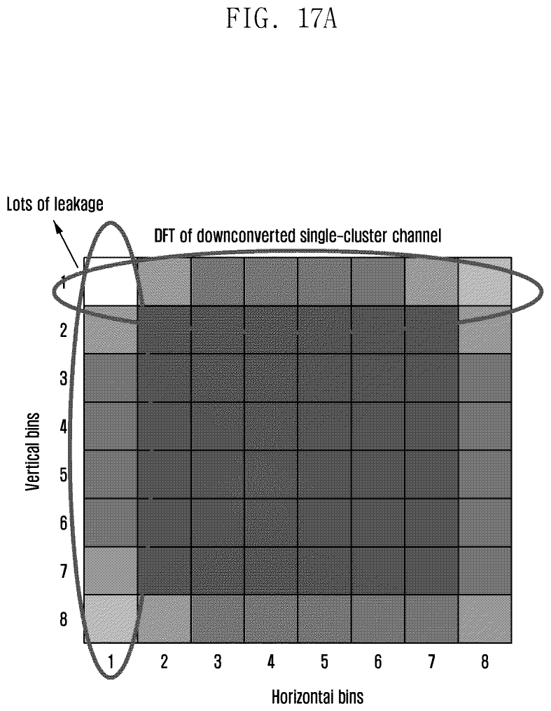

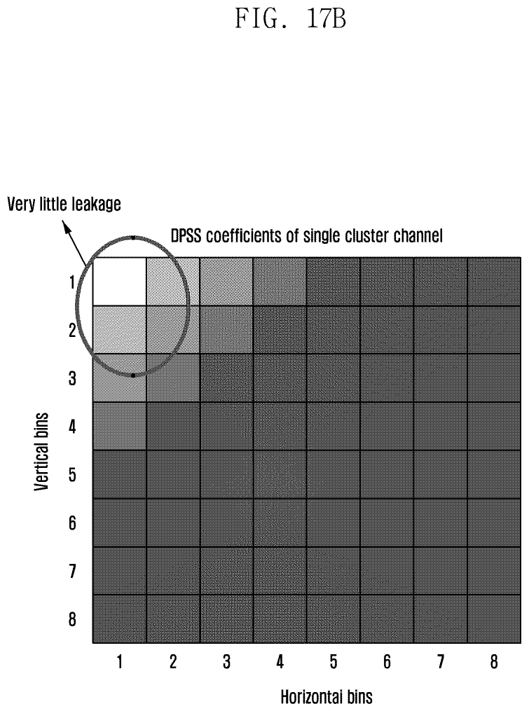

FIGS. 17A and 17B depict example of leakages of down converted low pass 2D FFT signal of a CDL channel. It can be seen that leakage for the Slepian is less. Therefore there are very few basis coefficients that need to be reported.

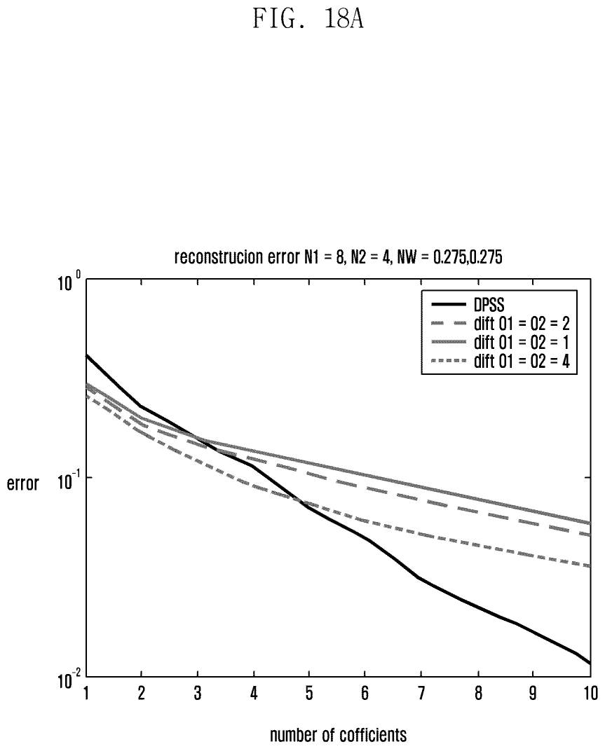

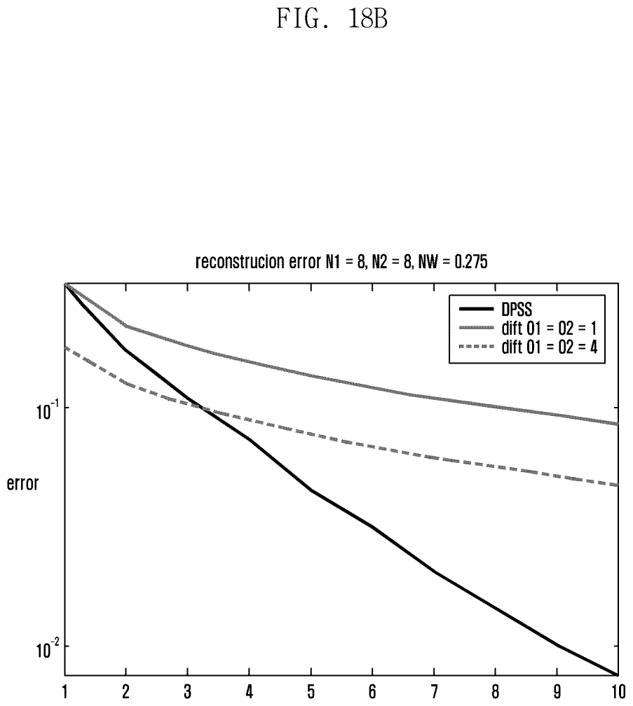

FIGS. 18A and 18B depict example reconstruction errors for the Slepian basis and the DFT basis.

According to an embodiment, a method (400) for providing a Channel State Information (CSI) feedback in a wireless communication system may be provided.

According to an embodiment, the method may include receiving, by a User Equipment (UE) (102), a plurality of Channel State Information Reference Signals (CSI-RS) from a base station (104) in an Observation Window (OW).

According to an embodiment, the method may include predicting, by the UE (102), at least one channel for each sub-band in selected time instants in a Prediction Window (PW).

According to an embodiment, the method may include estimating, by the UE (102), at least one basis and at least one relevant basis coefficient of the predicted at least one channel in the PW.

According to an embodiment, the method may include projecting, by the UE (102), the predicted at least one channel on to the estimated at least one basis.

According to an embodiment, the method may include reporting, by the UE (102), the at least one relevant basis coefficient of the predicted channel projected on to at least one basis to the base station (104); wherein the base station (104) reconstructs the at least one channel in the PW using the received basis coefficients.

According to an embodiment, the method may include receiving, by the UE (102), a downlink in the PW from the base station (104).

According to an embodiment, the method may include receiving, by the UE (102), a downlink in the PW from the base station (104), may include: predicting, by the base station (104), the at least one pre-coder for the downlink for the UE (102) using the received basis coefficients for reconstructing the at least one channel in the PW.

According to an embodiment, the method may include transmitting, by the base station (104), the downlink using the predicted at least one pre-coder to the UE (102) for at least one time instant in the PW.

According to an embodiment, the UE (102) may predict the at least one channel in a delay domain over the PW and reporting the at least one relevant basis coefficient for the at least one channel in the delay domain over the PW.

According to an embodiment, wherein the predicted at least one channel may be the channel between the base station (104) and the UE (102) or elements of parts of precoder matrices across time in the PW (the parts of precoder matrices are w2 or w2˜).

According to an embodiment, the UE (102) may receive the plurality of CSI-RS across a plurality of sub-bands from the base station (104) for various time instants in the OW.

According to an embodiment, wherein the at least one basis may include at least one of a Slepian (discrete prolate spheroidal sequence) basis, a Fast Fourier transform (FFT) basis, a Discrete Cosine Transform (DCT) basis, a Discrete Fourier Transform (DFT) basis, an oversampled DFT basis, a polynomial basis and other relevant basis.

According to an embodiment, wherein the oversampled DFT basis may provide the CSI feedback using a differential reporting (differences with respect to a reference reported along with the reference) of location and values of Doppler frequency components, corresponding to the at least one channel in the sub-band or in the delay domain for various time instants in the PW.

According to an embodiment, a User Equipment (UE) (102) including a processor (106) may be provided.

According to an embodiment, the processor (106) may be configured to: receive a plurality of Channel State Information Reference Signals (CSI-RS) from a base station (104) in an Observation Window (OW);

According to an embodiment, the processor (106) may be configured to predict at least one channel for each sub-band in selected time instants in a Prediction Window (PW).

According to an embodiment, the processor (106) may be configured to estimate at least one basis and at least one relevant basis coefficient of the predicted at least one channel in the PW.

According to an embodiment, the processor (106) may be configured to: project the predicted at least one channel on to the estimated at least one basis.

According to an embodiment, the processor (106) may be configured to report the at least one relevant basis coefficient of the predicted channel projected on to at least one basis to the base station (104), wherein the base station (104) is configured to reconstruct the at least one channel in the PW using the received basis coefficients.

According to an embodiment, the processor (106) may be configured to receive a downlink in the PW from the base station (104).

According to an embodiment, the base station (104) may be configured to predict the at least one pre-coder for the downlink for the UE (102) using the received basis coefficients for reconstructing the at least one channel in the PW.

According to an embodiment, the base station (104) may be configured to transmit the downlink using the predicted at least one pre-coder to the UE (102) for at least one time instant in the PW.

According to an embodiment, the processor (106) may be configured to predict the at least one channel in a delay domain over the PW and report the at least one relevant basis coefficient for the at least one channel in the delay domain over the PW.

According to an embodiment, wherein the predicted at least one channel may be the channel between the base station (104) and the UE (102) or elements of parts of precoder matrices across time in the PW (the parts of precoder matrices are w2 or w2˜).

According to an embodiment, the processor (106) may be configured to receive the plurality of CSI-RS across a plurality of sub-bands from the base station (104) for various time instants in the OW.

According to an embodiment, the at least one basis may include at least one of a Slepian (discrete prolate spheroidal sequence) basis, a Fast Fourier transform (FFT) basis, a Discrete Cosine Transform (DCT) basis, a Discrete Fourier Transform (DFT) basis, an oversampled DFT basis, a polynomial basis and other relevant basis.

According to an embodiment, the oversampled DFT basis may provide the CSI feedback using a differential reporting (differences with respect to a reference reported along with the reference) of location and values of Doppler frequency components, corresponding to the at least one channel in the sub-band or in the delay domain for various time instants in the PW.

According to an embodiment, a base station (104) including a processor (112) may be provided.

According to an embodiment, the processor (112) may be configured to transmit a plurality of Channel State Information Reference Signals (CSI-RS) to a User Equipment (UE) (102) in an Observation Window (OW).

According to an embodiment, the processor (112) may be configured to receive at least one basis coefficient of a channel projected at least one basis, where at least one channel predicted by the UE (102) is projected on to the at least one basis.

According to an embodiment, the processor (112) may be configured to predict at least one pre-coder for a downlink in a Prediction Window (PW) for the UE (102) using the received basis coefficients for reconstructing the at least one channel.

According to an embodiment, the processor (112) may be configured to transmit the downlink in the PW using the predicted at least one pre-coder to the UE (102) for at least one time instant.

According to an embodiment, a method (800) for using Slepian sequences or other basis for spatial domain basis for codebook based enhancements may be provided.

According to an embodiment, the method may include receiving, by a User Equipment (UE) (102), a plurality of Channel State Information Reference Signals (CSI-RS) from a base station (104) across a plurality of sub-bands.

According to an embodiment, the method may include estimating, by the UE (102), a two-dimensional (2D) channel matrix for each receiver and each sub-band in the UE (102) and all transmit antennas in the base station (104) that has a 2D layout.

According to an embodiment, the method may include reporting, by the UE (102), the estimated 2D channel matrix to the base station (104) for each receiver and each sub-band in the UE (102).

According to an embodiment, the base station (104) may reconstruct the at least one channel for the reported 2D channel matrix and calculates at least one precoder based on the reconstructed at least one channel for a downlink transmission.

According to an embodiment, the method may include receiving, by the UE (102), the downlink from the base station (104).

According to an embodiment, the UE (102) may estimate a one-dimensional (1D) channel matrix if a channel layout of the transmit antennas in the base station (104) is 1D.

According to an embodiment, the UE (102) may estimate the 2D channel matrix using a 2D Fast Fourier Transform (2D FFT).

According to an embodiment, the UE (102) may determine a location and number of clusters in the estimated 2D FFT of the 2D channel matrix.

According to an embodiment, the UE (102) may down convert each cluster based on a 2D exponential.

According to an embodiment, the UE (102) may project the down converted each cluster onto a 2D signal basis or a 2D signal subspace to obtain signal basis coefficients.

According to an embodiment, the 2D signal subspace may be composed of basis vectors of at least one of a Slepian (discrete prolate spheroidal sequence) basis, a Fast Fourier transform (FFT) basis, a Discrete Cosine Transform (DCT) basis, a Discrete Fourier Transform (DFT) basis, an oversampled DFT basis, a polynomial basis and other basis.

According to an embodiment, the UE (102) may report a plurality of relevant signal basis coefficients of the 2D signal basis along with the 2D exponential to the base station (104), for each of the clusters in the at least one channel.

According to an embodiment, the base station (104) may reconstruct the at least one channel and calculates the at least one precoder for a later downlink transmission to the UE (102).

According to an embodiment, a User Equipment (UE) (102) including a processor (106) may be provided.

According to an embodiment, the processor (106) may be configured to receive a plurality of Channel State Information Reference Signals (CSI-RS) from a base station (104) across a plurality of sub-bands.

According to an embodiment, the processor (106) may be configured to estimate a two-dimensional (2D) channel matrix for each receiver and each sub-band in the UE (102) and all transmit antennas in the base station (104) that has a 2D layout.

According to an embodiment, the processor (106) may be configured to report the estimated 2D channel matrix to the base station (104) for each receiver and each sub-band in the UE (102), where the base station (104) is configured to reconstruct at least one channel for the reported 2D channel matrix and calculate at least one precoder based on the reconstructed at least one channel for a downlink transmission.

According to an embodiment, the processor (106) may be configured to receive the downlink from the base station (104).

According to an embodiment, the processor (106) may be configured to estimate a one-dimensional (1D) channel matrix if a channel layout of the transmit antennas in the base station (104) is 1D.

According to an embodiment, the 2D channel matrix may be estimated using a 2D Fast Fourier Transform (2D FFT).

According to an embodiment, the processor (106) may be configured to determine a location and number of clusters in the estimated 2D FFT of the 2D channel matrix.

According to an embodiment, the processor (106) may be configured to down convert each cluster based on a 2D exponential.

According to an embodiment, the processor (106) may be configured to project the down converted each cluster onto a 2D signal basis or a 2D signal subspace to obtain signal basis coefficients.

According to an embodiment, wherein the 2D signal subspace may be composed of basis vectors of at least one of a Slepian (discrete prolate spheroidal sequence) basis, a Fast Fourier transform (FFT) basis, a Discrete Cosine Transform (DCT) basis, a Discrete Fourier Transform (DFT) basis, an oversampled DFT basis, a polynomial basis and other basis.

According to an embodiment, the processor (106) may be configured to report a plurality of relevant signal basis coefficients of the 2D signal basis along with the 2D exponential to the base station (104), for each of the clusters in the at least one channel.

According to an embodiment, the base station (104) may be configured to reconstruct the at least one channel and calculate the at least one precoder for the reported clusters for a later downlink transmission to the UE (102).

According to an embodiment, a base station (104) including a processor (112) may be provided.

According to an embodiment, the processor (112) may be configured to transmit a plurality of Channel State Information Reference Signals (CSI-RS) to a User Equipment (UE) (102) across a plurality of sub-bands.

According to an embodiment, the processor (112) may be configured to receive an estimated two-dimensional (2D) channel matrix from the UE (102) for each receiver and each sub-band in the UE (102), where the UE (102) estimates the 2D channel matrix for each receiver and each sub-band in the UE (102) and all transmit antennas in the base station (104) that has a 2D layout.

According to an embodiment, the processor (112) may be configured to reconstruct at least one channel for the received 2D channel matrix and calculate at least one precoder based on the reconstructed at least one channel for a downlink transmission.

According to an embodiment, the processor (112) may be configured to transmit the downlink using the predicted at least one pre-coder to the UE (102) based on the reconstructed at least one channel.

The embodiments disclosed herein can be implemented through at least one software program running on at least one hardware device and performing network management functions to control the network elements. The network elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the spirit and scope of the embodiments as described herein.

1. A method performed by a user equipment (UE) in a communication system, the method comprising:
receiving, from a base station, a plurality of channel state information reference signals (CSI-RSs) in an observation window (OW);
predicting at least one channel for each sub-band in selected time instants in a prediction window (PW);
estimating at least one basis and at least one relevant basis coefficient of the predicted at least one channel in the PW;
projecting the predicted at least one channel on to the estimated at least one basis;
reporting, to the base station, the at least one relevant basis coefficient of the predicted channel projected on to at least one basis; and
receiving, from the base station, a downlink in the PW.

2. The method of claim 1, the downlink is based on at least one pre-coder for the downlink and for at least one time instant in the PW associated with the at least one relevant basis coefficient for reconstructing the at least one channel in the PW.

3. The method of claim 1,
wherein the at least one channel is predicted in a delay domain over the PW,
wherein the at least one relevant basis coefficient for the at least one channel is reported in the delay domain over the PW, and
wherein the predicted at least one channel is a channel between the base station and the UE or elements of parts of precoder matrices across time in the PW.

4. The method of claim 1, wherein the plurality of CSI-RS are received across a plurality of sub-bands from the base station for various time instants in the OW.

5. The method of claim 1, wherein the at least one basis comprises at least one of a slepian (discrete prolate spheroidal sequence) basis, a fast fourier transform (FFT) basis, a discrete cosine transform (DCT) basis, a discrete fourier transform (DFT) basis, an oversampled DFT basis, a polynomial basis and other relevant basis, and
wherein the oversampled DFT basis provides CSI feedback using a differential reporting of location and values of doppler frequency components, corresponding to the at least one channel in the sub-band or in a delay domain for various time instants in the PW.

6. A user equipment (UE) in a communication system, the UE comprising:
a transceiver; and
a processor coupled with the transceiver and configured to:
receive, from a base station, a plurality of channel state information reference signals (CSI-RSs) in an observation window (OW);
predict at least one channel for each sub-band in selected time instants in a prediction window (PW);
estimate at least one basis and at least one relevant basis coefficient of the predicted at least one channel in the PW;
project the predicted at least one channel on to the estimated at least one basis;
report, to the base station, the at least one relevant basis coefficient of the predicted channel projected on to at least one basis; and
receive, from the base station, a downlink in the PW.

7. A method performed by a base station in a communication system, the method comprising:
transmitting, to a user equipment (UE), a plurality of channel state information reference signals (CSI-RSs) in an observation window (OW);
receiving at least one basis coefficient of a channel projected at least one basis, wherein at least one channel is projected on to the at least one basis;
predicting at least one pre-coder for a downlink in a prediction window (PW) for the UE using the at least one basis coefficient for reconstructing the at least one channel; and
transmitting, to the UE, the downlink in the PW using the predicted at least one pre-coder for at least one time instant.

8. A base station in a communication system, the base station comprising:
a transceiver; and
a processor coupled with the transceiver and configured to:
transmit, to a user equipment (UE), a plurality of channel state information reference signals (CSI-RSs) in an observation window (OW);
receive at least one basis coefficient of a channel projected at least one basis, wherein at least one channel is projected on to the at least one basis;
predict at least one pre-coder for a downlink in a prediction window (PW) for the UE using the at least one basis coefficient for reconstructing the at least one channel; and
transmit, to the UE, the downlink in the PW using the predicted at least one pre-coder for at least one time instant.

9-15. (canceled)

16. The UE of claim 6, the downlink is based on at least one pre-coder for the downlink and for at least one time instant in the PW associated with the at least one relevant basis coefficient for reconstructing the at least one channel in the PW.

17. The UE of claim 6, wherein the at least one channel is predicted in a delay domain over the PW,
wherein the at least one relevant basis coefficient for the at least one channel is reported in the delay domain over the PW, and
wherein the predicted at least one channel is a channel between the base station and the UE or elements of parts of precoder matrices across time in the PW.

18. The UE of claim 6, wherein the plurality of CSI-RS are received across a plurality of sub-bands from the base station for various time instants in the OW.

19. The UE of claim 6, wherein the at least one basis comprises at least one of a slepian (discrete prolate spheroidal sequence) basis, a fast fourier transform (FFT) basis, a discrete cosine transform (DCT) basis, a discrete fourier transform (DFT) basis, an oversampled DFT basis, a polynomial basis and other relevant basis, and
wherein the oversampled DFT basis provides CSI feedback using a differential reporting of location and values of doppler frequency components, corresponding to the at least one channel in the sub-band or in a delay domain for various time instants in the PW.
